(19) United States
(12) Patent Application Publication
(10) Pub. No.: US 2011/0296354 A1
(43) Pub. Date: Dec. 1, 2011

(54) Content-Driven Navigation

(75) Inventors: Nicholas Zambetti, San Francisco, CA (US); Astrid van der Flier, San Francisco, CA (US); Jesse Tane, San Francisco, CA (US); Katrin B. Gosling, Woodside, CA (US); Coe Leta Rayne Stafford, Millbrae, CA (US); Martin Nicholas John Heaton, San Francisco, CA (US); Matthew Robert Adams, Mountain View, CA (US); Peter Riering-Czekalla, Oakland, CA (US); Andrew Switky, Menlo Park, CA (US); Michael Gibson, Evergreen, CO (US); Richard Cerami, Denver, CO (US)

(73) Assignee: QWEST COMMUNICATIONS INTERNATIONAL INC., Denver, CO (US)

(21) Appl. No.: 12/982,024

(22) Filed: Dec. 30, 2010

Related U.S. Application Data
(60) Provisional application No. 61/331,342, filed on May 4, 2010.

(51) Int. Cl. G06F 3/048

(52) U.S. Cl. 715/854

(57) ABSTRACT

Solutions for providing intuitive, content-driven navigation through communications and multimedia services offered through, e.g., a user supersystem as a communications hub. For example, in some implementations, various data flows are traversed to move between applications according to interactions with content on those screens, rather than by using icons. In some cases, a small, static set of icons is used to navigate between a set of landing screens representing broad categories of functionality. Within each landing screen environment, content is used to drive navigation to and through application functionality.

### CROSS-REFERENCES TO RELATED APPLICATIONS

This application claims the benefit, under 35 U.S.C. §119(e), of provisional U.S. Application Ser. No. 61/331,342, filed on May 4, 2010 by Zambetti et al. and entitled “Content-Driven Navigation” (attorney docket no. 020366-104700US), the entire disclosure of which is incorporated herein by reference. This application may also be related to the following commonly-assigned, co-pending applications (the “Related Applications”), the entire disclosure of each which is hereby incorporated by reference:
U.S. application Ser. No. 12/773,742, filed May 4, 2010, by Gibson et al. and entitled “Multi-Client Local Network Base Station” (attorney docket no. 020366-103700US);
U.S. application Ser. No. 12/773,747, filed May 4, 2010 by Zambetti et al. and entitled “Family Chat” (attorney docket no. 020366-103900US);
U.S. application Ser. No. ______, filed on a date even herewith by Mehin et al. and entitled “Integrated Multi-Modal Chat” (attorney docket no. 020366-104010US), which claims the benefit of provisional U.S. Application Ser. No. 61/331,311, filed on May 4, 2010 by Mehin et al. and entitled “Integrated Multi-Modal Chat” (attorney docket no. 020366-104000US);
U.S. application Ser. No. ______, filed on a date even herewith by van der Flier et al. and entitled “Conversation Capture” (attorney docket no. 020366-104110US) which claims the benefit of provisional U.S. Application Ser. No. 61/331,316, filed on May 4, 2010 by van der Flier et al. and entitled “Conversation Capture” (attorney docket no. 020366-104100US);
U.S. application Ser. No. ______, filed on a date even herewith by Mehin et al. and entitled “Video Call Handling” (attorney docket no. 020366-104210US), which claims the benefit of provisional U.S. Application Ser. No. 61/331,337, filed on May 4, 2010 by Mehin et al. and entitled “Video Call Handling” (attorney docket no. 020366-104200US);
U.S. application Ser. No. ______, filed on a date even herewith by Zambetti et al. and entitled “Multi-User Integrated Task List” (attorney docket no. 020366-104310US), which claims the benefit of provisional U.S. Application Ser. No. 61/331,318, filed on May 4, 2010 by Zambetti et al. and entitled “Multi-User Integrated Task List” (attorney docket no. 020366-104300US);
U.S. application Ser. No. ______, filed on a date even herewith by van der Flier et al. and entitled “Integrated Messaging Interface” (attorney docket no. 020366-104410US), which claims the benefit of provisional U.S. Application Ser. No. 61/331,319, filed on May 4, 2010 by van der Flier et al. and entitled “Integrated Messaging Interface” (attorney docket no. 020366-104400US);
U.S. application Ser. No. ______, filed on a date even herewith by Zambetti et al. and entitled “Video Recording Environment” (attorney docket no. 020366-104510US), which claims the benefit of provisional U.S. Application Ser. No. 61/331,339, filed on May 4, 2010 by Zambetti et al and entitled “Video Recording Environment” (attorney docket no. 020366-104500US);
U.S. application Ser. No. ______, filed on a date even herewith by Zambetti et al. and entitled “Photo Stack” (attorney docket no. 020366-104610US), which claims the benefit of provisional U.S. Application Ser. No. 61/331,341, filed on May 4, 2010 by Zambetti et al. and entitled “Photo Stack” (attorney docket no. 020366-104600US);
U.S. application Ser. No. ______, filed on a date even herewith by Mehin et al. and entitled “Doodle-In-Chat Context” (attorney docket no. 020366-104810US), which claims the benefit of provisional U.S. Application Ser. No. 61/331,344, filed on May 4, 2010 by Mehin et al. and entitled “Doodle-In-Chat Context” (attorney docket no. 020366-104800US).

### FIELD

This disclosure relates, in general, to communications networks and services and, more particularly, to provision of enhanced communications and connectivity among users.

### BACKGROUND

In many typical communications environments, users interact with communications services through a local network. For example, users within a home, office, enterprise branch location, etc. may interface with outside networks through routers and/or other network access systems. As voice, video, Internet, and other types of communications services converge, and as user network devices become increasingly portable, the network access systems are increasingly becoming hubs for substantially all user communications in proximity to the user's local network.

The increase in convergence and portability has provided many new types of user devices for interacting with communications services through the user's local network. However, there is typically little interactivity between the devices. As such, it may be difficult and/or inconvenient to use the devices in an integrative fashion, for example, to facilitate an integrated family or office environment.

In addition, while the increased functionality of personal communications technology has provided many benefits, many users, and in particular users within a household, have sometimes had difficulty in adapting that technology to household communications patterns. It therefore would be beneficial for modern household communications systems to conform more closely to household users' communication patterns, rather than forcing the household users to conform to usage patterns imposed by the technology.

### BRIEF SUMMARY

Among other things, this disclosure describes tools and techniques for providing integrated, interactive communications services among multiple client devices in a local network. Some embodiments allow multiple user devices to be used in an integrative fashion to provide home management functionality, messaging functionality, videoconferencing functionality, cloud network interaction functionality, media sharing functionality, and/or other functionality. In another aspect, certain embodiments provide enhanced communication functionality by implementing chat, household activity tracking, media capture, and other communication functions in a manner that more closely conforms to typical household communications, resulting in an improve user experience, and in some cases, a more connected household.

One set of embodiments provides a communication system comprising a computing device. The communication system might also include other devices, such as a data store (which might take the form of a computer readable medium, and/or might include one or more databases, and/or the like), one or more display devices, one or more input devices, and one or more media capture devices (e.g., video capture devices, such as digital still or motion cameras, audio capture devices, such as microphones, and/or the like), all of which might be in communication with the computing device. In some cases, the data store, display devices, input devices, and/or media capture devices might be integrated within the computing device, while in other cases, they might be separate. In a particular aspect, the computing device might include (or be in communication with) one or more touch screens, which can serve as both a display device and an input device.

In an aspect, the computing device comprises at least one processor and at least one computer readable storage medium in communication with the at least one processor. The at least one computer readable storage medium might have encoded thereon a set of instructions that are executable by the processor to cause the computer system to perform one or more operations in accordance with the functionality of various embodiments, as described in further detail below and in the Related Applications. (It should be noted that, in some aspects, each of the Related Applications describe different feature sets that can be included and/or combined in any suitable fashion within particular embodiments.)\

In some cases, the computing device might be a general purpose computer, while in others it might take the form of a personal media device, smart phone, tablet computer, and/or the like. In still other cases, the computing device might be a special-purpose device designed specifically to provide the described functionality.

According to another set of embodiments, the computing device might be part of a supersystem that provides interactive communications services within a local network. The supersystem might include a tablet system, a handset system, and/or a base station system, any (or all) of which can serve as the computing device according to various implementations. The tablet system might include a first client subsystem and a first user interface module configured to provide interactivity with first communications services provided by the first client subsystem, the first client subsystem being communicatively coupled with the local network and a second client subsystem. The handset system might include a second client subsystem and a second user interface module configured to provide interactivity with second communications services provided by the second client subsystem, the second client subsystem being communicatively coupled with the local network and the first client subsystem. The base station system might include a first interface subsystem configured to removably couple the base station with the tablet system and a second interface subsystem configured to removably couple the base station with the handset system.

In one set of embodiments, the set of instructions is executable by the processor to cause the computing device to perform one or operations that might be considered part of a method (which itself can be a separate embodiment). Thus, the tools provided by various embodiments can include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible and/or non-transitory computer readable media (such as, to name but a few examples, optical media, magnetic media, and/or the like).

Merely by way of example, in one embodiment, a communication system for providing content-driven navigation might comprise a computing device (e.g., as described above), as well as an input device, a video capture device (e.g., a digital camera), and/or a display device, any or all of which might be integrated within the computing device or might be separate from the computing device.

The set of instructions for controlling operation of the device might include, for example, instructions for generating a hierarchical set of navigation screens to serve as a portal to content-related activities. In one aspect, the hierarchical set of navigation screens might comprise a first level of a navigation screen hierarchy, the first level comprising one or a plurality of landing screens, including a first landing screen comprising a first type of content. In another aspect, the hierarchical set of navigation screens might further comprise a second level of the navigation screen hierarchy, the second level comprising one or a plurality of application screens, including without limitation a first application screen, the first application screen providing a user interface for interacting with the first type of content using a first application.

In some embodiments, the set of instructions further comprises instructions for displaying, on the display screen, the first landing screen, and/or instructions for receiving, with the input device, a user interaction with the first type of content. The set of instructions, then, might further comprise instructions for displaying the first application screen, in response to the interaction with the first type of content, and/or instructions for providing functionality to the user, with the first application, pertaining to the first type of content. In other cases, the first level of the hierarchy might comprise plurality of landing screens in addition to the first landing screen, including in particular a second landing screen. The first landing screen might comprise a plurality of icons corresponding to the plurality of landing screens, including an icon corresponding to the second landing screen. In such cases, the set of instructions might further comprise instructions for receiving a user selection of the icon corresponding to the second landing screen, and/or instructions for displaying the second landing screen, in response to the user selection of that icon.

In an aspect of some embodiments, the first landing screen is a default landing screen. In such cases, the set of instructions might further comprise instructions for displaying the first landing screen when the system starts up. Alternatively and/or additionally, the set of instructions might comprise instructions for displaying the first landing screen after a period of system inactivity.

In accordance with other embodiments, the first application screen further comprises a second type of content, and the second level of the navigation screen hierarchy further comprises a second application screen, the second application screen providing a user interface for interacting with the second type of content using a second application. The set of instructions might further include instructions for receiving a second user interaction with the second type of content, and/or instructions for displaying the second application, in response to the second user interaction with the second type of content. There might also be instructions for providing functionality to the user, with the second application, pertaining to the second type of content.

In some cases, the first type of content might comprise media content, such as a photo, a video clip, and/or an audio clip, to name a few examples. In that case, the first application might be a media album application, a media capture application, etc. Alternatively, the first application might be a media capture application, and the communication system might include a media capture device (such as a camera, microphone, etc.) The set of instructions, then, might comprise instructions for capturing, with the media capture application, additional media of the first type, received from the media capture device. In other embodiments, the first media type might be messaging content, and the first application might be a message create application, or the first type of content might be address book content, and the first application might be a phone application.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1A shows a simplified block diagram of an illustrative user supersystem in communication with a provider network, according to various embodiments.

FIG. 1B shows a simplified block diagram of another illustrative user supersystem in communication with a provider network, where the base station system provides little or no communications functionality, according to various embodiments.

FIG. 1C shows a simplified block diagram of yet another illustrative user supersystem in communication with a provider network, where the base station system physically interfaces only with the tablet system, and where certain standard tablet system and handset system components are used, according to various embodiments.

FIG. 2 shows a communications system that includes a user network having multiple clients, according to various embodiments.

FIG. 3 shows a communications system that includes multiple user networks, according to various embodiments.

FIG. 4 shows a functional block diagram of a base station system in the context of certain other devices and systems, according to various embodiments.

FIG. 5 shows a functional block diagram of a client subsystem in the context of certain other devices and systems, according to various embodiments.

FIG. 6 shows a simplified block diagram of an illustrative computational system for use in implementing components of various embodiments.

FIG. 7 illustrates an exemplary video capture environment, in accordance with various embodiments.

FIG. 8 shows a shows a simplified block diagram of a content data flow for providing content-based navigation functionality, according to various embodiments.

FIG. 9 shows a shows a simplified block diagram of a content data flow for providing content-based navigation functionality, according to various embodiments.

FIGS. 10-17 are exemplary screen shots showing examples of user interfaces that may be presented to a user, in accordance with various embodiments.

### DETAILED DESCRIPTION

The present invention relates, in general, to providing communications and media services through a graphical interface and, more particularly, to providing intuitive, content-driven navigation through those services.

In many typical communications environments, users interact with communications services through a local network. For example, users within a home, office, enterprise branch location, etc. may interface with outside networks through routers and/or other network access systems. As voice, video, Internet, and other types of communications services converge, and as user network devices become increasingly portable, the network access systems are increasingly becoming hubs for substantially all user communications in proximity to the user's local network.

The increase in convergence and portability has provided many new types of user devices for interacting with communications services through the user's local network. However, there is typically little interactivity between the devices. As such, it may be difficult and/or inconvenient to use the devices in an integrative fashion, for example, to facilitate an integrated family or office environment.

Embodiments allow multiple user devices to be used in an integrative fashion to provide home management functionality, messaging functionality, videoconferencing functionality, cloud network interaction functionality, media sharing functionality, and/or other functionality. According to some embodiments, a supersystem is provided that includes at least one base station and at least two clients. Functionality of the supersystem and its component systems will be appreciated through various illustrative embodiments described herein.

The following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below and, while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

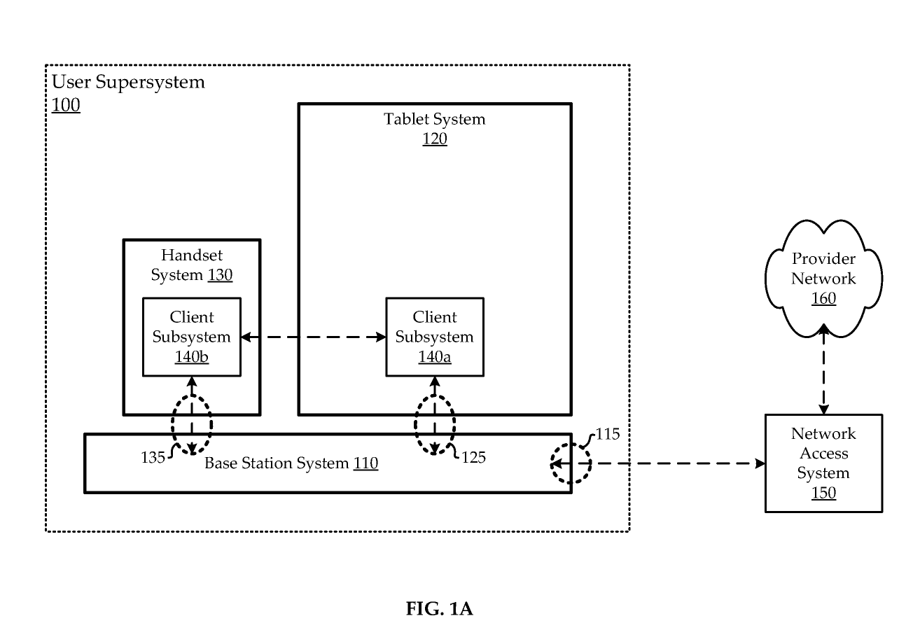

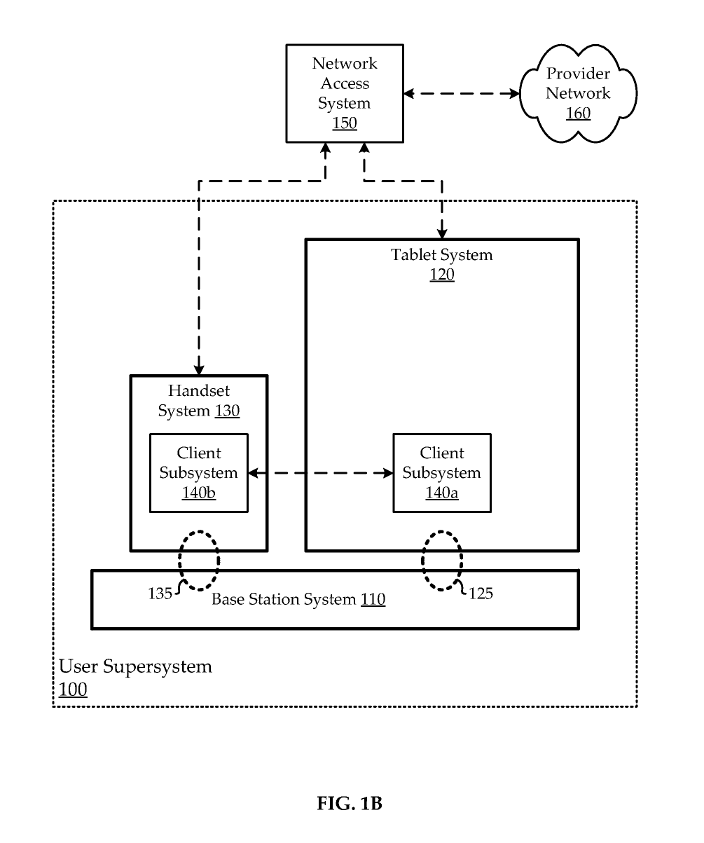

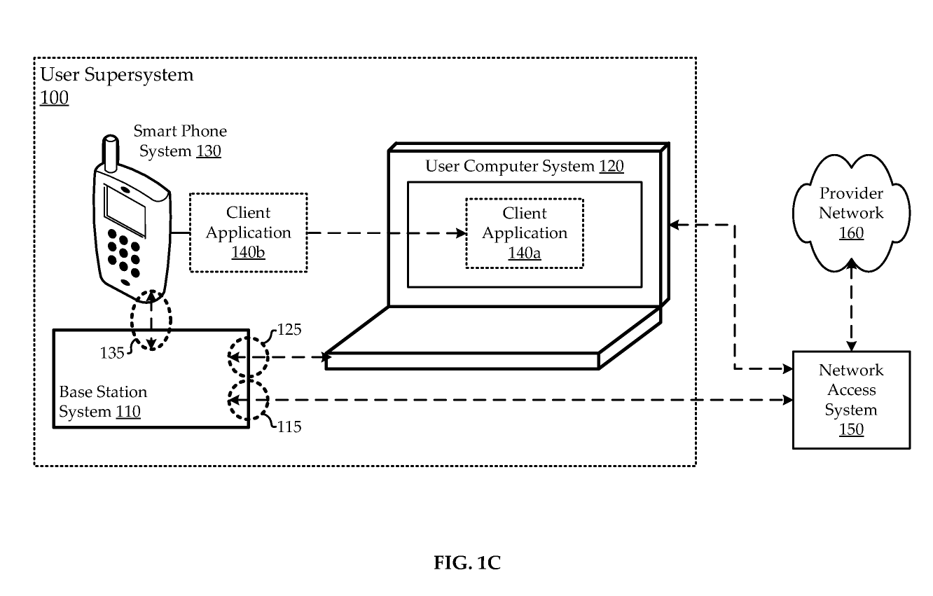

Turning first to FIG. 1A, a simplified block diagram is shown of an illustrative user supersystem 100 in communication with a provider network 160, according to various embodiments. The user supersystem 100 includes a base station system 110, a tablet system 120, and a handset system 130. Each of the tablet system 120 and the handset system 130 includes a client subsystem 140.

The user supersystem 100 interfaces with the provider network 160 via a network access system 150. As described more fully below, the network access system 150 may include a network interface device (NID), a router (e.g., a network address translation (NAT) router), and/or any other component used to provide subnet functionality. For example, because of the network access system 150, the user supersystem 100 may operate in the context of a local network. As used herein, “local network,” “user network,” “home network,” and similar phraseology is used broadly and interchangeably to include any type of subnet, like a local area network (LAN). It is understood that different types of local networks may be used in various embodiments without departing from the scope of the invention. For example, different local networks may operate using different protocols, different types of security, different architectures or topologies, etc.

In various embodiments, the tablet system 120, the handset system 130, and/or the base station system 110 are configured to provide interactive communications services to the client subsystems 140 within the local network. For example, the tablet system 120 and the handset system 130 may provide a user with communications functionality for interacting with a public network (e.g., the Internet), with the provider network 160 (e.g., for various provider services, like cloud storage and application serving), with other devices on the local network (e.g., computers, smart appliances, baby monitors, networked televisions, etc.), etc. Further, as described more fully below, the interactive communications functionality may include integrations between the tablet system 120 and the handset system 130 (e.g., application hand-offs and integrations, off-loading, etc.). The various features of the user supersystem 100 are implemented through its various component systems—the base station system 110, the tablet system 120, and the handset system 130. Each of these components systems will be described in turn.

Embodiments of the base station system 110 are configured with different types of functionality. In some embodiments, the base station system 110 is configured as a base for mounting one or both of the tablet system 120 and the handset system 130. For example, a tablet interface region 125 and a handset interface region 135 may be configured to physically receive a portion of the tablet system 120 and handset system 130, respectively (e.g., for docking). In another embodiment, the base station system 110 is configured as a special-purpose mount for interfacing the tablet system 120 and/or the handset system 130 with a fixture or other element (as an under-cabinet mount).

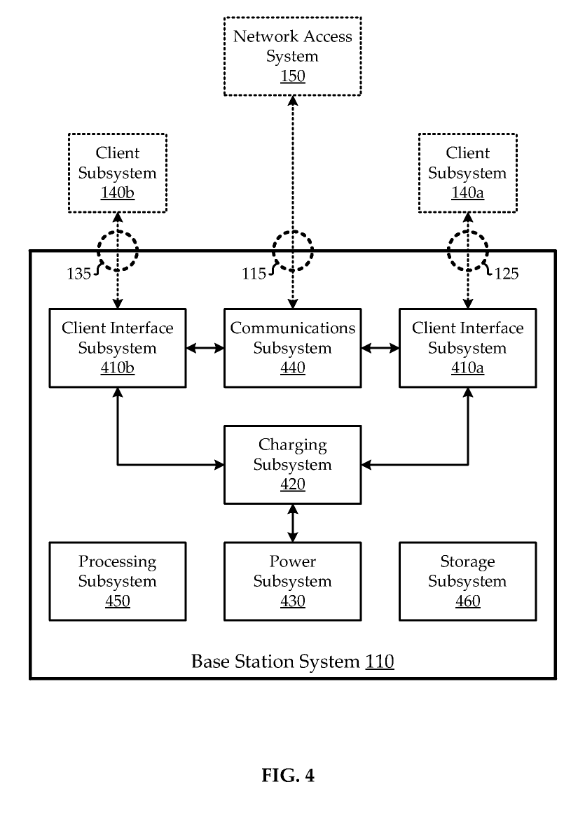

According to other embodiments, the base station system 110 includes charging functionality for charging the tablet system 120 and/or the handset system 130. For example, the charging may be contactless (e.g., by induction) or by physical ports and/or cables configured to interface with cables and/or ports on the respective tablet system 120 or handset system 130. According to still other embodiments, the base station system 110 includes communications functionality. Embodiments of the base station system 110 may be configured to provide the functionality of a wireless fidelity (WiFi) hotspot, a wireless repeater, a network hub, a network router (e.g., with or without network address translation (NAT) functionality), a picocell or femtocell, etc. For example, as shown, the base station system 110 may include a network interface region 115 for interfacing with the network access system 150. Certain embodiments may provide interactive communications between the provider network 160 (e.g., and/or other networks) and the client subsystems 140 (e.g., via the tablet interface region 125 and the handset interface region 135). These and other functions of the base station system 110 will be described more fully below (e.g., with reference to FIG. 4).

Other functionality of the user supersystem 100 is provided by the tablet system 120, the handset system 130, and/or their respective client subsystems 140. Embodiments of the tablet system 120 are typically implemented substantially as a tablet computing environment. The tablet system 120 may include a large display. The display may be active or passive; responsive to touch by a finger, stylus, or other implement; responsive to remote interactions, etc. Other interactivity may be provided by voice capture (e.g., audio-to-text translation, direct voice recording, etc.), by motion capture (e.g., gestures, etc.), and or in any other useful way.

In some embodiments, the tablet system 120 includes additional input/output components or features. Embodiments include a still and/or video capture device (e.g., a digital video camera), an integrated speaker, and/or ports (e.g., physical and/or logical) for interfacing with peripheral devices. For example, the tablet system 120 may be configured to interface with peripheral cameras, keyboards, printers, scanners, sensors, etc. In certain embodiments, the tablet system 120 interfaces with one or more peripherals via the base station system 110. For example, the base station system 110 may include a USB hub or a Bluetooth receiver, by which the tablet system 120 interfaces with a compatible keyboard.

In some embodiment, a digital video camera is integrated within the chassis of the tablet system 120, such that it can be pointed in various directions. In one embodiment, the camera swivels to point either in a direction substantially normal to the display (e.g., typically toward the primary user of the tablet system 120) or in an opposite direction (e.g., typically away from the primary user of the tablet system 120). Video captured by the camera may also be displayed substantially in real time on the display.

For example, suppose a first user employs the tablet system 120 to place a video call with a second user to show off a new home renovation. The first user may be able to see both the first user's camera input and the second user's camera input (e.g., as picture-in-picture, side-by-side, etc.) on the first user's display. By pointing the camera in a direction opposite the display and walking around the renovation with the tablet system 120, the first user may see both what the second user is seeing (i.e., the new renovation video capture) and the second user's reaction on the same display at the same time.

Embodiments of the handset system 130 provide various types of functionality, some similar to that of the tablet system 120. The handset system 130 may typically be implemented in a physical format similar to that of a cell phone, personal digital assistant (PDA), remote control, etc. (i.e., portable and ergonomic). The handset system 130 may be configured to receive user interactions through various types of controls. For example, some or all of the controls may be implemented as soft controls through a touch screen, additional controls may be implemented as hard buttons, etc. In certain embodiments, the handset system 130 includes a camera. In one embodiment, the camera is substantially identical to that of the tablet system 120. Of course, the handset system 130 may include additional components, such as microphones and speakers, ports and jacks, etc.

Notably, as described more fully below, embodiments of the tablet system 120 and the handset system 130 are designed and configured to provide an integrated experience. Using the example above, suppose a first user has employed the tablet system 120 to place a video call with a second user to show off a new home renovation. During the call, the first user decides that it would be more convenient to walk around with the handset system 130. The first user may pick up the handset system 130 and continue the call (e.g., substantially seamlessly hand off the video call from the tablet system 120 to the handset system 130). In one embodiment, the tablet system 120 and/or the handset system 130 may display a soft button (e.g., “send to handset”) to execute the hand-off. In another embodiment, removing the handset system 130 from the base station system 110 may automatically initiate the hand-off. In another embodiment, moving the handset system 130 out of direct proximity to the tablet system 120 (e.g., separating them by more than eighteen inches) may automatically initiate the hand-off.

While the tablet system 120 and the handset system 130 are described above with reference to certain hardware components (e.g., cameras, displays, etc.), it will be appreciated that much of the functionality of those systems is in fact implemented by their respective client subsystems 140. In various embodiments, each client subsystem 140 may be a “hard” client subsystem 140, a “soft” client subsystem 140, or some combination. For example, the client subsystem 140 may be implemented, in whole or in part, in hardware. Thus, it may include one or more Application Specific Integrated Circuits (ASICs) adapted to perform a subset of the applicable functions in hardware. Alternatively, the functions may be performed by one or more other processing units (or cores), on one or more integrated circuits (ICs). In other embodiments, other types of integrated circuits may be used (e.g., Structured/Platform ASICs, Field Programmable Gate Arrays (FPGAs), and other Semi-Custom ICs), which may be programmed. Each may also be implemented, in whole or in part, with instructions embodied in a computer-readable medium, formatted to be executed by one or more general or application specific controllers.

In some embodiments, as illustrated by the dashed line between client subsystems 140, there may be communications between the client subsystems 140. In some embodiments, the communications are direct between components of the client subsystems 140 themselves. In other embodiments, the communications are routed through components of the tablet system 120 and the handset system 130. In still other embodiments, the communications are routed through components of the base station system 110. And in other embodiments, the communications are routed through one or more other components of the local network, for example, the network access system 150.

It will be appreciated that many types of user supersystem 100 are possible with many types and/or numbers of component systems. For the sake of illustration, some of these alternate embodiments are described with reference to FIGS. 1B and 1C. For example, in some embodiments, the base station system 110 does not provide any communications functionality. FIG. 1B shows a simplified block diagram of another illustrative user supersystem 100 in communication with a provider network 160, where the base station system 110 provides little or no communications functionality, according to various embodiments.

As in FIG. 1A, the user supersystem 100 includes a base station system 110, a tablet system 120, and a handset system 130. Each of the tablet system 120 and the handset system 130 includes a client subsystem 140. In the embodiment of FIG. 1B, however, the network access system 150 is illustrated as being in direct communication with the tablet system 120 and the handset system 130, and not through the base station system 110. For example, each of the tablet system 120 and the handset system 130, and/or their respective client subsystems 140, may be configured to communicate directly with the local network (e.g., with the network access system 150.

It is worth noting that, where the base station system 110 does not provide communications functionality, there may be no need for a network interface region 115. Further, there may be no need to provide communications via the tablet interface region 125 or the handset interface region 135. For example, unlike in the embodiment of FIG. 1A, there may be no physical and/or logical (e.g., unwired) communications path between the base station system 110 and the tablet system 120 or the handset system 130 via the tablet interface region 125 or the handset interface region 135, respectively. Still, interface regions of the base station system 110 may provide various types of mounting functionality, charging functionality, etc., for example, as described above.

FIG. 1C shows a simplified block diagram of yet another illustrative user supersystem 100 in communication with a provider network 160, where the base station system 110 physically interfaces only with the tablet system 120, and where certain standard tablet system 120 and handset system 130 components are used, according to various embodiments. Again, as in FIG. 1A, the user supersystem 100 includes a base station system 110, a tablet system 120, and a handset system 130, and each of the tablet system 120 and the handset system 130 includes a client subsystem 140.

As illustrated, the tablet system 120 may be implemented as a standard (e.g., multi-purpose, undedicated) laptop or tablet computing environment, and the handset system 130 may be implemented as a standard smart phone environment. The client subsystems 140 are also shown as client applications. For example, some functionality of the client subsystem 140b shown as part of the handset system 130 of FIG. 1A may be implemented as an application running on a standard smart phone. In alternate embodiments, a dedicated handset system 130 (e.g., as shown in FIG. 1A) may be used with a standard tablet system 120 (e.g., as shown in FIG. 1C), or a standard handset system 130 (e.g., as shown in FIG. 1C) may be used with a dedicated tablet system 120 (e.g., as shown in FIG. 1A).

Other types of base station system 110 may be used as well, according to various embodiments. For example, as illustrated, the base station system 110 may be configured to physically interface with (e.g., provide docking for) the handset system 130 via a handset interface region 135, and to provide communications with the tablet system 120 via the tablet interface region 125 (e.g., by a wired or unwired communications path).

Further, the user supersystem 100 may interface with the local network in various ways. As illustrated, the base station system 110 is in communication with the network access system 150, the tablet system 120 is shown in communication both with the base station system 110 and with the network access system 150, and the handset system 130 is shown in communication only with the base station system 110. Of course, in alternate embodiments, the base station system 110 may not be in communication with the local network (e.g., as described with reference to FIG. 1B), the handset system 130 may have a direct communications path to the network access system 150, etc.

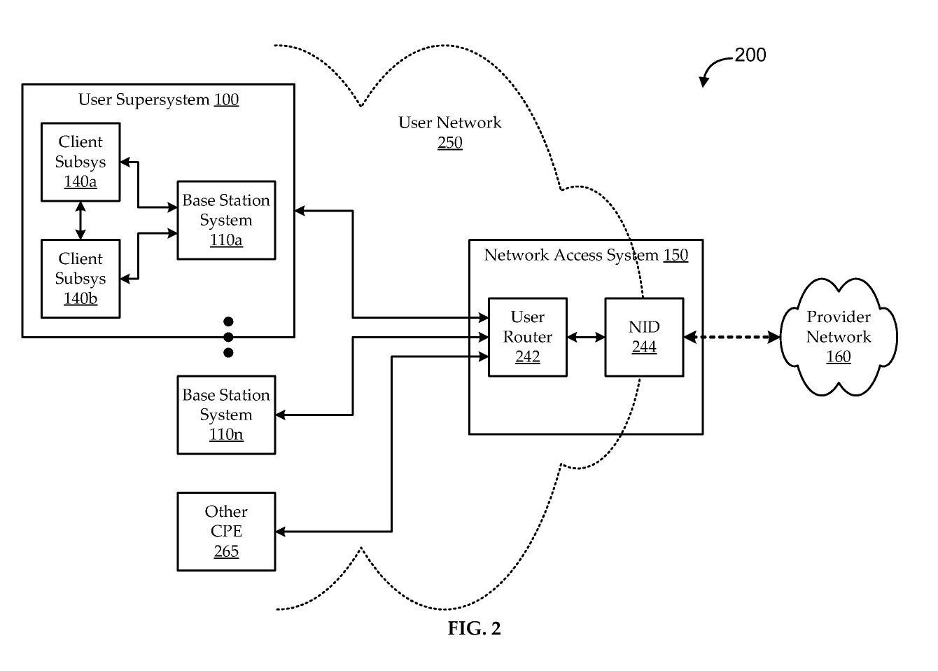

While each of the illustrative embodiments shown in FIGS. 1A-1C shows a single user supersystem 100 alone in its local network, user supersystems 100 may operate in the context of other devices in a local network. FIG. 2 shows a communications system 200 that includes a user network 250 having multiple clients, according to various embodiments. As illustrated, the user network 250 includes a user supersystem 100 and other devices in communication with a provider network 160 via a network access system 150.

It will be appreciated that many types of provider network 160 are possible. For example, the provider network 160 may include a cable, direct subscriber line (DSL), satellite, and/or other type of network topology. Further, different types of provider networks 160 may include different topologies or architectures between portions of the provider network 160 and between other networks, such as the Internet.

For example, according to one type of network topology, access networks from individual customers are aggregated in one or more locations within the provider network 160 (e.g., apartment access networks maybe aggregated at a building level, again at a neighborhood level, again at a service area level, etc.), with various aggregated regions being serviced by one or more main provider locations (e.g., central offices). At those or other locations, the provider network 160 may interface with other networks, for example, through various types of peering relationships, etc. Typically, non-customers may interface with customers in the provider network 160 through the public network.

As such, different types of network architectures and topologies may be used with various embodiments, such that different types of components may be required and/or desired at a user's premises to interface with an access portion of the provider network 160. For example, various types of receivers, ports, modems, etc. may be used at the user premises to interface the user's user network 250 with the provider network 160. The interface between the user network 250 and the provider network 160 may be implemented by components of the network access system 150.

In one embodiment, the network access system 150 includes a NID 244 and a user router 242. The NID 244 may include some or all of the components used to interface the user's access portion of the provider network 260 (e.g., the phone line, cable, fiber, etc. going to the user's home) with the user's premises. The NID 244 may be mounted internal or external to the user's premises (e.g., or some combination), and may include regions that are restricted to the user (e.g., accessible only to a service provider). In various embodiments, the NID 244 may provide various types of functionality, including network address translation, switching, routing, filtering, serving (e.g., using a micro-server), storage, cooling, monitoring, etc.

In embodiments where the NID 244 does not include a router or where additional routing is desired, the network access system 150 may further include the user router 242. The user router 242 may include a network address translator (NAT) router, a port address translation (PAT) device, a single-address NAT, a port-level multiplexed NAT, a static or dynamic NAT, a firewall, etc. The router may be particularly useful where multiple devices within the user network 250 are being used to communicate outside the user network 250, as in FIG. 2.

Regardless of the particulars of the provider network 160 and the network access system 150, the result may be manifest as a local user network 250. For example, the network access system 150 may include any components or functionality desired to provide services from the provider network 160 to the user network 250 and/or among the devices within the user network 250, such that the user network 250 operates as a subnet.

As illustrated, the user network 250 may include a user supersystem 100, an additional base station system 110n, and one or more other customer premises equipment (CPE) devices 265. For example, the CPE devices 265 may include computer systems (e.g., laptops, personal computers, tablet computers, etc.), television equipment (e.g., networked or Internet-enabled television sets, set-top boxes, etc.), smart phones, smart appliances (e.g., networked lighting, refrigerators, water heaters, etc.), sensor equipment (e.g., smoke or radon alarms, thermostats, baby monitors, etc.), etc. Of course, any other types or numbers of devices or systems may be included in the user network 250. Each of these devices or systems may be in direct or indirect communication with the network access system 150 (e.g., via the user router 242).

Multiple base station systems 110 may be used in a topology, like the one illustrated in FIG. 2, to provide certain enhanced functionality. As described above, the base station systems 110 may be configured to provide certain types of communications functionality. For example, the base station systems 110 may act as Wi-Fi hotspots or repeaters. When there are multiple base station systems 110 in the user network 250, the client subsystems 140 may be configured to interface with the base station system 110 having the strongest signal (e.g., or the closest base station system 110, the base station system 110 having certain functionality, etc.).

It will be appreciated that these and/or other techniques may be used to provide a substantially ubiquitous unwired connectivity experience throughout the user's premises. Notably, changes in signal integrity may affect apparent latency, error rates, bandwidth, and/or other connectivity conditions. For example, as a home user moves between room or floors, and even external to the home within some range, it may be desirable for the user to experience a substantially consistent connectivity experience.

For example, the user supersystem 100 is illustrated as including two client subsystems 140 in communication with each other and with a first base station system 110a. If one or both of the client subsystems 140 is moved out of operational range of the first base station system 110a and into operational range of a second base station system 110n, the one or both client subsystems 140 may automatically switch to being in communication with the second base station system 110n. Accordingly, the user supersystem 100 definition may dynamically update to capture changes in topology.

For the sake of illustration, a customer calls a fabric seller to inquire about a particular fabric. A video session is initiated, beginning with the fabric seller sitting at her desk in front of the tablet system 120 of her user supersystem 100 (e.g., acting as a first client subsystem 140a). She desires to show the customer the requested fabric, while also illustrating the breadth of her fabric stock and the attractiveness of her storefront to entice the customer to visit in person. To this end, she seamlessly hands the video session off to her handset system 130 (e.g., acting as a second client subsystem 140b) and virtually walks the customer (i.e., via real-time video capture) through the store to the location of the requested fabric, all the while remotely watching the customer's reaction on the handset system 130 display. The requested fabric is located on the second floor of the store, far from the base station system 110 (e.g., which may be collocated with the tablet system 120). However, the fabric seller has an additional base station system 110 configured as a repeater on the second floor for boosting the signal in that area of the store (e.g., for when the handset system 130 is in proximity). As such, she is able to maintain a high quality, real-time video stream with her customer throughout the communications session.

It will be appreciated that other types of integrations are possible in a user network 250, like the one illustrated in FIG. 2. For example, as described above, the client subsystems 140 may interact and/or be integrated with each other. Further, in certain embodiments, the client subsystems 140 may be configured to interface with one or more other CPE devices 265. For example, the tablet system 120 may be configured to display a monitor of current energy use by smart appliances in the home, to remotely control lights and/or other devices in the home, to monitor a closed caption video feed (e.g., from a security system), etc. These types of integrations may be implemented by direct communication links, through one or more base station systems 110, through components of the network access system 150, through other devices in the user network 250, etc.

Of course, it may be desirable for devices or systems in one user network 250 to interface with devices or systems in another user network 250. Each of the illustrative embodiments shown in FIGS. 1A-1C shows only a single user supersystem 100, and the embodiment of FIG. 2 shows only a single user network 250. However, user supersystems 100 may typically operate in the context of a larger communications system having multiple users with multiple user networks 250, each having multiple devices and systems.

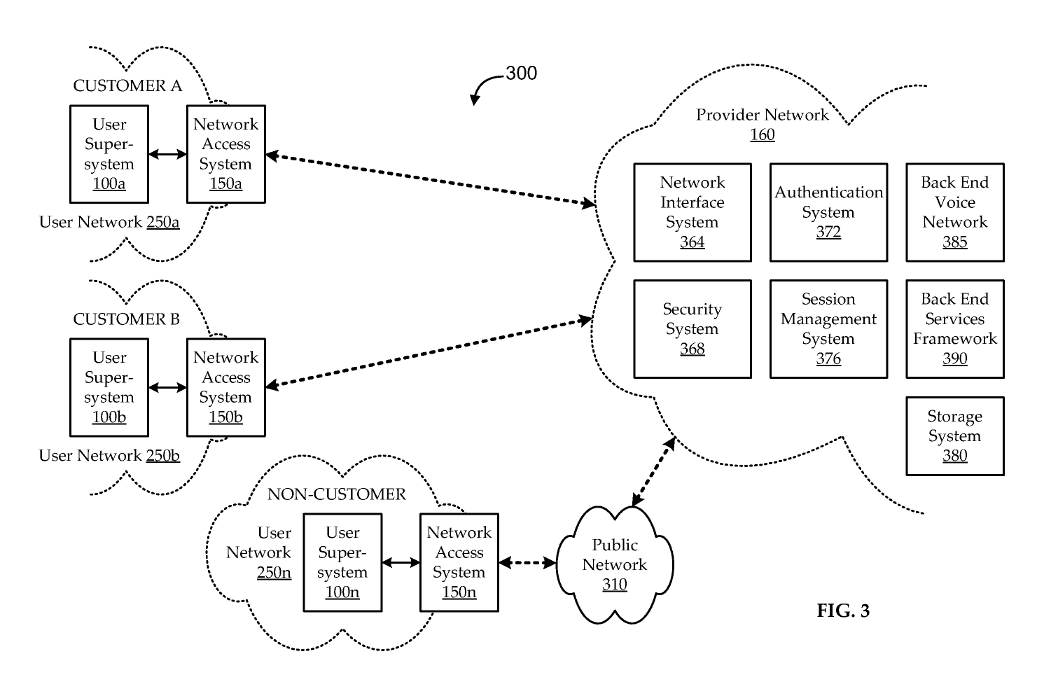

FIG. 3 shows a communications system 300 that includes multiple user networks 250, according to various embodiments. As illustrated, the user network 250 includes a user supersystem 100 in communication with a common provider network 160 via a network access system 150. Notably, a first user network 250a is associated with a first customer (“Customer A”) of the service provider associated with the provider network 160, a second user network 250b is associated with a second customer (“Customer B”) of the service provider, and a third user network 250c is associated with a user that is not a customer of the service provider (“Non-Customer”).

As described above, in some network topologies, customers may be in substantially direct communication with the provider network 160, while non-customers may have access to the provider network 160 only through the public network 310 (e.g., the Internet). In certain embodiments, the communications to and from the respective network access systems 150 are substantially the same, regardless of whether the user network 250 is associated with a customer. In other embodiments, certain additional or alternate functionality is available to customers. For example, when the service provider has less or no control over the access network to a user (e.g., for non-customers), provision of certain services may be difficult, impractical, or impossible (e.g., provision of certain services may be to slow, too costly, etc. when offered through the public network). In still other embodiments, various types of relationships (e.g., peering relationships, content delivery or mirroring relationships, etc.) may be used to provide similar services to both customers and non-customers.

Typically, services are provided by the service provider from the provider network 160. As illustrated, the provider network 160 may be described in terms of a number of functional blocks. For example, the provider network 160 may include a network interface system 364, a security system 368, an authentication system 372, a session management system 376, a storage system 380, a back-end voice network 385, and a back-end services framework 390. Notably, these functional blocks may, in fact, be collocated or distributed, implemented in one or more components or systems, implemented in hardware or software, etc., according to various embodiments. As such, descriptions of functionality of the provider network 160 in this context is intended to add clarity to the description and should not be construed as limiting the scope of embodiments.

In some embodiments, communications to and from various user networks 250 (e.g., via their respective network access systems 150) interface with the provider network 160 at the network interface system 364. Embodiments of the network interface system 364 may include any type of components, subsystems, etc. for interfacing with the user access networks, with the public network 310, and/or with additional networks (e.g., content delivery networks (CDNs), back-haul networks, peer networks, proprietary networks, etc.). For example, the network interface system 364 may include and handle various ports and connections, implement signal processing functions (e.g., modulations and demodulations), implement protocol handling, etc.

In some embodiments, communications are further handled by the security system 368. For example, it may be desirable for functionality of the network interface system 364 to be enhanced with logical security (e.g., firewalls, encryption, etc.) and/or with physical security (e.g., locked servers, etc.). Notably, functionality of the security system 368 may be further applied to other systems of the provider network 160. For example, physical and/or logical security may be applied to some or all of the authentication system 372, storage system 380, etc.

In addition to the types of security provided by the security system 368, other types of user (e.g., or device, system, network, etc.) authentication may be desired. Embodiments of the authentication system 372 are used for authorization, authentication, accounting, registration, and/or other similar functionality. For example, the authentication system 372 may include functionality of an “Authentication, Authorization, and Accounting” (AAA) server, a “Remote Authentication Dial In User Service” (RADIUS), etc. In one embodiment, the network interface system 364 implements a Network Access Server (NAS) in communication with a RADIUS server implemented by the authentication system 372.

In other embodiments, the authentication system 372 may be used to perform other types of authentication and registration. In one embodiment, new devices in a user network 250 may send a registration request to the authentication system 372, which may keep track of and/or authorize user devices. In another embodiment, individual communications sessions are authorized, registered, etc. by the authentication system 372. In still another embodiment, the authentication system 372 handles authentication credentials of non-customers (e.g., using cookies, etc.), content providers, etc. In yet other embodiments, the authentication system 372 handles additional accounting functions, such as usage tracking against fair access policies (FAPs), etc.

As discussed above, embodiments of the user supersystems 100 provide interactive communications functionality via client subsystems 140. In some embodiments, certain functionality is provided in the context of communication sessions. For example, session streams may be used to manage large numbers of simultaneous communications transactions occurring over the communications network 300 (e.g., chat sessions, voice or video calls, messaging, content delivery, etc.). In some embodiments, these session streams are handled by the session management system 376.

Embodiments of the session management system 376 may manage session in various ways, depending on the type of session. For example, certain embodiments may manage and/or contribute to classifications of service flows as unicast, multicast, broadcast, simulcast, etc. As such, the session management system 376 may be configured to assign and manage session identifiers, handle session persistence, handle session protocol usage, etc. In some embodiments, the session management system 376 implements the Session Initiation Protocol (SIP) for some or all of the session streams. For example, SIP may be used by the session management system 376 as a signaling protocol, for handling multi-user communications, including streaming media, voice or video calls (e.g., voice over Internet protocol (VoIP) calls), instant messaging, real-time gaming, etc.

It will be appreciated that the network interface system 364, security system 368, authentication system 372, session management system 376, and/or other functional blocks of the provider network 160 may effectively provide various front-end types of functionality. For example, services delivered to the users may be provided by back-end systems, other content sources, etc. The front-end functional blocks described my, thus, effectively mediate provision of those services to users via their respective client subsystems 140.

As illustrated, back-end functionality may be provided by the back-end voice network 385, the back-end services framework 390, and the storage system 380. For example, voice calls and certain data flows may be handled by the back-end voice network 385. Embodiments of the back-end voice network 385 may include the plain old telephone service (POTS) network and/or other voice networks, such as packet-switched networks (e.g., via fiber-optic networks, DSL networks, etc.).

Embodiments of the back-end services framework 390 include and/or interface with all other service provision of the provider network 160. In some embodiments, the back-end services framework 390 provides integrated messaging functionality. For example, different types of messaging capabilities may be provided between user supersystems 100, between different client subsystems 140, from a user supersystem 100 to other user devices inside or outside of the user network 250, etc. The messaging functionality may include e-mail messaging, Short Message Service (SMS) messaging, video messaging, etc.

The back-end services framework 390 may also provide various cloud computing and/or content serving functionality. For example, in certain embodiments, the storage system 380 includes a storage area network (SAN) within the provider network 160. In other embodiments, the storage system 380 includes, or is in communication with, data storage (e.g., servers) over external networks. For example, the storage system 380 may include third-party storage offered over the Internet. The back-end services framework 390 may use the storage system 380 to provide functionality, including, for example, content mirroring, application serving, and cloud-based address books, photo albums, calendars, etc.

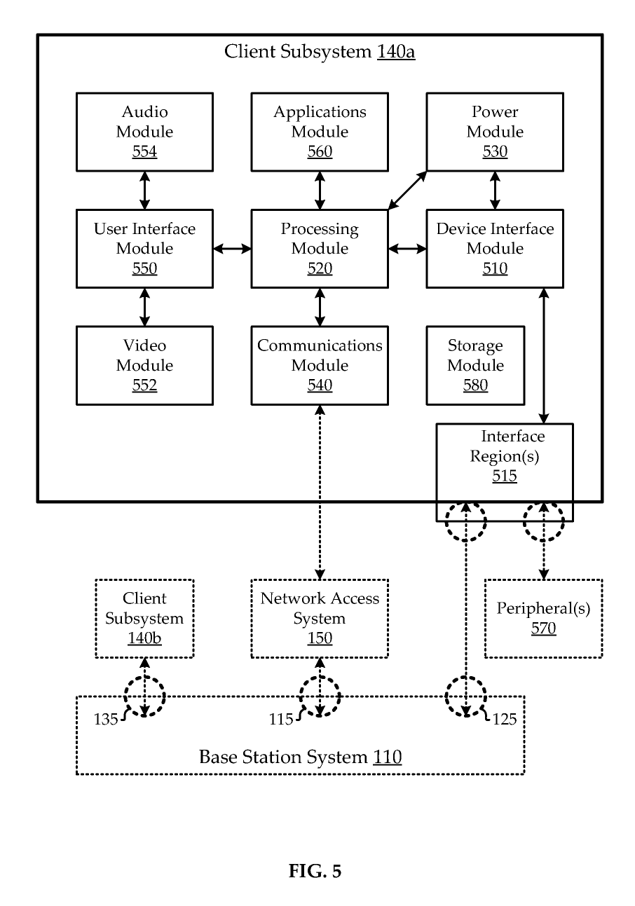

It will be appreciated that other functionality may be provided by embodiments of the back-end services framework 390 and/or other components of the provider network 160. Of course, much of the functionality described with reference to components of the provider network 160 may related to (e.g., rely on, be further integrated with, be enhanced by, etc.) components of the user supersystem 100. For the sake of additional clarity, embodiments of some functional components of illustrative base station systems 110 and client subsystems 140 are described with reference to FIGS. 4 and 5, respectively.

FIG. 4 shows a functional block diagram of a base station system 110 in the context of certain other devices and systems, according to various embodiments. For example, embodiments of the base station system 110 may be implemented substantially as described with reference to FIG. 1A. For the sake of clarity and to add context to the description, the base station system 110 is shown in communication with a first client subsystem 140a, a second client subsystem 140b, and a network access system 150 via a tablet interface region 125, a handset interface region 135, and a network interface region 115, respectively. It will be appreciated from the descriptions above that many other arrangements are possible according to other embodiments. As such, the context should not be construed as limiting the scope of the embodiments.

Many functions of embodiments of the base station system 110 are provided by various functional blocks. As illustrated the functional blocks may include one or more client interface subsystems 410, a charging subsystem 420, a power subsystem 430, a communications subsystem 440, a processing subsystem 450, and a storage subsystem 560. For example, embodiments of the client interface subsystems 410 are configured to interface with one or more of the client subsystems 140, physically and/or logically.

In some embodiments, the client interface subsystems 410 of the base station system 110 include physical features for mounting one or both of the tablet system 120 and the handset system 130. For example, the client interface subsystems 410 include the tablet interface region 125 and handset interface region 135, configured to physically receive a portion of the tablet system 120 and handset system 130, respectively. In one embodiment, the physical receiving is used to provide docking functionality for one or more client subsystems 140.

In other embodiments, the client interface subsystems 410 include mounting features designed to removably couple the base station system 110 with the tablet system 120, for example, so that the otherwise portable tablet system 120 remains in place for certain uses. As one example, the tablet system 120 includes a touch screen for use in typing, drawing, dragging, and/or other types of user interactivity. Using the base station system 110 to secure the tablet system 120 while typing, etc. may improve the user experience.

In still other embodiments, the client interface subsystems 410 include feature that configure the base station system 110 as a special-purpose mount for interfacing the tablet system 120 and/or the handset system 130 with a fixture or other element. For example, embodiments of the base station system 110 may provide under-cabinet mounting functionality for use in a kitchen, so that the tablet system 120 can be swung down from under the kitchen cabinets when in use and swung out of the way otherwise.

In even other embodiments, the client interface subsystems 410 provide support for functionality of other components. For example, charging functionality of the charging subsystem 420 and/or communications functionality of the communications subsystem 440 may be implemented in part through features of the client interface subsystems 410.

Embodiments of the base station system 110 include the charging subsystem 420, configured to provide charging functionality for charging one or more client subsystems 140 or their associated devices (e.g., the tablet system 120 and/or the handset system 130 of FIG. 1A). In certain embodiments, the charging is contactless (e.g., by induction). In certain other embodiments, the charging functionality is provided by physical ports and/or cables configured to interface with cables and/or ports on the respective devices (e.g., the tablet system 120, handset system 130, etc.). These charging functions may use features of the client interface subsystems 410.

For example, in one embodiment, a handset system 130 in which one client subsystem 140b is implemented includes two conductive contacts and a magnetic element in proximity to the bottom of its chassis. The corresponding client interface subsystem 410b of the base station system 110 similarly includes two conductive contacts and a magnetic element as part of the handset interface region 135. When the handset system 130 is coupled with the base station system 110, the magnetic elements hold the handset system 130 in place while the conductive contacts facilitate the flow of charging current to the handset system 130, as managed by the charging subsystem 420. In some embodiments, the charging functionality of the charging subsystem 420 is enhanced in one or more ways. For example, the base station system 110 may provide functionality for charge monitoring, error detection, battery failure, quick charging, etc.

Of course, embodiments of the charging subsystem 420 may require a source of power from which to provide charging current. In some embodiments, the charging subsystem 420 is coupled with the power subsystem 430. Some embodiments of the power subsystem 430 may simply provide an interface between the base station system 110 and a power source (e.g., a wall outlet). Other embodiments of the power subsystem 430 include additional functionality. For example, the power subsystem 430 may process (e.g., clean, convert, regulate, step up or step down, etc.) the input power, monitor and/or regulate power consumption of the base station system 110 and/or other devices, provide different levels for different functions (e.g., provide constant output current to the charging subsystem 420, low-voltage output to internal circuitry of the base station system 110, regulated power to a cooling fan, etc.), etc.

As described above, some embodiments of the base station system 110 include the communications subsystem 440 for providing certain communications functionality. In various embodiments, the base station system 110 is configured (using functionality of the communications subsystem 440) to act as a wireless fidelity (Wi-Fi) hotspot, a wireless repeater, a network hub, a network router (e.g., with or without network address translation (NAT) functionality), a picocell or femtocell, etc. For example, as shown, the communications subsystem 440 may include the network interface region 115 for interfacing with the network access system 150.

In one embodiment, the network interface region 115 includes a physical port for plugging into a network (e.g., an Ethernet port). In another embodiment, the network interface region 115 includes an unwired (e.g., wireless, cellular, etc.) receiver for interfacing with a local network via the network access system 150. The network interface region 115 may also include one or more logical ports, antennae, and/or any other useful network interface component. In certain embodiments, the network access system 150 is implemented within a chassis of the base station system 110, such that connections with the network access system 150 are internal to the base station system 110, and may or may not include physical connections (e.g., the connections may be logical or functional connections between functional components or modules).

Certain embodiments of the communications subsystem 440 provide interactive communications functionality (e.g., from other devices, the user network, the provider network, and/or other networks) to the client subsystems 140. For example, the communications subsystem 440 may be coupled with the client interface subsystems 410 such that communications services may be provided via the tablet interface region 125 and the handset interface region 135. Alternately, the communications subsystem 440 may include additional transceivers, logical ports, etc. For example, embodiments of the communications subsystem 440 may include Bluetooth communications components, USB hubs, radio antennae, etc.

In various embodiments of the base station system 110, functionality of the various functional blocks is supported by one or more of the processing subsystem 450 and the storage subsystem 460. For example, embodiments of the processing subsystem 450 include a central processing unit and/or dedicated processors (e.g., communications processors, graphics processors, etc.). Embodiments of the storage subsystem 460 may include a hard disk drive, a flash drive, a micro server, a data processing engine, and/or any other useful storage and/or data management components.

It will be appreciated that various embodiments of the base station system 110 may include only some of the functional blocks shown in FIG. 4 and, accordingly, only some of the functionality described above. Further, in some embodiments, the functionality of the base station system 110 is integrated into a single chassis. In other embodiments, certain functionality may be offloaded to peripheral devices (e.g., a USB storage drive as part of the storage subsystem 460, or an external signal booster as part of the communications subsystem 440) or distributed among multiple components. In still other embodiments, the chassis of the base station system 110 includes additional or alternate features. For example, the chassis may include various device interfaces (e.g., recesses, locks, ports, plugs, etc.), controls (e.g., buttons, switches, etc.), physical features (e.g., cooling fins, rubberized feet, etc.), etc.

It will be further appreciated that much of the functionality described above with reference to the base station system 110, and additional functionality of embodiments of user supersystems 100, may be implemented by the client subsystems 140. FIG. 5 shows a functional block diagram of a client subsystem 140a in the context of certain other devices and systems, according to various embodiments. For example, embodiments of the client subsystem 140a may be implemented substantially as described with reference to FIG. 1A. For the sake of clarity and to add context to the description, the client subsystem 140a is shown in communication with a network access system 150, a base station system 110 and one or more peripheral devices 570. The base station system 110 is shown in communication with the client subsystem 140a, another client subsystem 140b, and the network access system 150, via a tablet interface region 125, a handset interface region 135, and a network interface region 115, respectively.

It will be appreciated from the descriptions above that many other arrangements are possible according to other embodiments. As such, the context should not be construed as limiting the scope of the embodiments. For example, while the description will focus on client subsystem 140a, the same or different functional blocks may be included in client subsystem 140b. Notably, the client subsystem 140a is intended to broadly show illustrative functionality of a client subsystem 140, whether part of a dedicated device system (e.g., like the tablet system 120 or the handset system 130 of FIG. 1A), part of an undedicated device system (e.g., like the tablet system 120 or the handset system 130 of FIG. 1C), etc.

Embodiments of the client subsystem 140a may implement various functionality through functional blocks. As illustrated, the functional blocks may include a device interface module 510, one or more interface regions 515, a processing module 520, a power module 530, a communications module 540, a user interface module 550, a video module 552, an audio module 554, an applications module 560, and a storage module 580. As described above, embodiments of the client subsystem 140a may be incorporated within a device chassis.

Embodiments of the device interface module 510 are configured to provide an interface between the client subsystem 140 (e.g., or its respective device chassis) and either the base station system 110, a peripheral device 570, or some other device or component. For example, embodiments of the device interface module 510 may functionally correspond to embodiments of a client interface subsystem 410 of a base station system 110, as described with reference to FIG. 4.

In some embodiments, the device interface module 510 may be coupled with interface regions 515 that provide physical and/or logical components or features to support certain types of interfaces. For example, the interface regions 515 may include metal contacts (e.g., to facilitate charging from the base station system 110), a headphone or headset jack (e.g., for audio input/output), various internal ports or slots (e.g., for a battery, a memory card, a Subscriber Identity Module (SIM) card, etc.), etc. In one embodiment, the interface regions 515 include features for interfacing directly with the base station system 110 (e.g., via the tablet interface region 125 or the handset interface region 135). In another embodiment, the interface regions 515 include features for interfacing between the client subsystem 140a and another client subsystem 140 (e.g., between a handset system 130 and a tablet system 120). In yet another embodiment, the interface regions 515 are configured to support functionality of the communications module 540, as described more below.

Embodiments of the client subsystem 140a include a processing module 520. The processing module 520 may include a central processor, a graphics processor, an audio processor, and/or any other useful dedicated or multi-purpose processing components. For example, embodiments of the processing module 520 are designed to support functionality of other functional modules of the client subsystem 140a.

In some embodiments, the client subsystem 140a includes a power module 530. Embodiments of the power module 530 may deliver power to other functional modules, manage power consumption, process (e.g., clean, regulate, etc.) power, etc. Other functionality of the power module 530 may be appreciated in the context of other types of functionality. For example, if an external active device is being used, the device may draw power from the client subsystem 140a, and that power delivery may be controlled by the power module 530. In another example, during a charging or discharging cycle of a battery, the power module 530 may control and/or monitor charging or discharging current.

Other embodiments of the client subsystem 140a include a communications module 540. Embodiments of the communications module 540 provide various types of communications functionality. For example, as illustrated, the communications module 540 may handle communications with the base station system 110 and/or the network access system 150. In some embodiments, the communications module 540 performs a number of client-side functions, such as handling of requests, messaging, communications sessions, proxy functions, etc. In certain embodiments, the communications module 540 uses functionality of the device interface module 510 and/or other functional modules, for example, to manage certain types of communication flows with certain types of other devices or systems (e.g., for protocol management, demodulation, etc.).

Still other embodiments of the client subsystem 140a include a user interface module 550. In some embodiments, the user interface module 550 handles inputs and outputs through the video module 552, the audio module 554, and/or the peripheral devices 570. For example, embodiments of the video module 552 include a camera and a display. The display may be active or passive; responsive to touch by a finger, stylus, or other implement; responsive to remote interactions, etc.

Embodiments of the camera include a digital video camera integrated within the chassis of the client subsystem 140a, such that it can be pointed in various directions. In one embodiment, the camera swivels to point either in a direction substantially normal to the display (e.g., typically toward the primary user of the tablet system 120) or in an opposite direction (e.g., typically away from the primary user of the tablet system 120). Video captured by the camera may also be displayed substantially in real time on the display. The camera may also be configured to take still images.

Embodiments of the audio module 554 may include audio input components (e.g., microphones) and audio output devices (e.g., speakers). Input and/or output functionality of the user interface module 550 may be further implemented through peripheral devices, such as peripheral cameras, keyboards, printers, scanners, sensors, etc. In certain embodiments, the client subsystem 140a is configured to interface with one or more input/output devices via the base station system 110. For example, the base station system 110 may include a USB hub or a Bluetooth receiver, by which the client subsystem 140a interfaces with a compatible keyboard. Other interactivity may also be provided by voice capture (e.g., audio-to-text translation, direct voice recording, etc.) through the audio module 554, by motion capture (e.g., gestures, etc.) through the video module 552, and/or in any other useful way.

It will be appreciated that much of the functionality of the various modules described above may be designed substantially to support delivery of certain applications to a user of the client subsystem 140a. Embodiments of the client subsystem 140a include an applications module 560 for handling applications through the client subsystem 140a. In various embodiments, the applications module 560 uses functionality of other modules, such as the user interface module 550, the processing module 520, and the communications module 540 to implement applications functions.

Applications delivery by the applications module 560 and/or other types of functionality of the client subsystem 140a may be further supported by local storage through the storage module 580. Embodiments of the storage module 580 may include disk drives, flash drives, and/or other data storage and processing components. In certain embodiments, the storage module 580 is configured to integrate functionally with external storage, for example, in the base station system 110 or in the “cloud” (e.g., offered via the Internet, the provider network, etc.).

It will be appreciated that, while many embodiments are described above with reference to a user supersystem 100 having two client subsystems 140 (e.g., in a tablet system 120 and a handheld system 130), other configurations and topologies are possible. In some embodiments, the user supersystem 100 includes one tablet system 120 and multiple handheld systems 130, for example, used throughout a home. In other embodiments, multiple tablet systems 120 are used as part of the user supersystem 100. In still other embodiments, other devices (e.g., in the home) include some or all of the functionality of the client subsystem 140 for operation as part of the user supersystem 100. For example, a client subsystem 140 may be implemented as part of an alarm clock, weather station, television set-top box, laptop computer, etc.

It will further be appreciated that various embodiments of client subsystems 140 may include only some of the functional blocks (or additional functional blocks to those) shown in FIG. 5. Accordingly, other embodiments may include only some of the functionality described above or different functionality from that described above. Further, it will be appreciated that some or all of the functionality of the client subsystems 140, and also some or all of the functionality of the base station system 110, may be implemented by a computational system. For example, dedicated and/or multi-purpose hardware and/or software may be used to implement many of the functions described with reference to FIGS. 4 and 5.

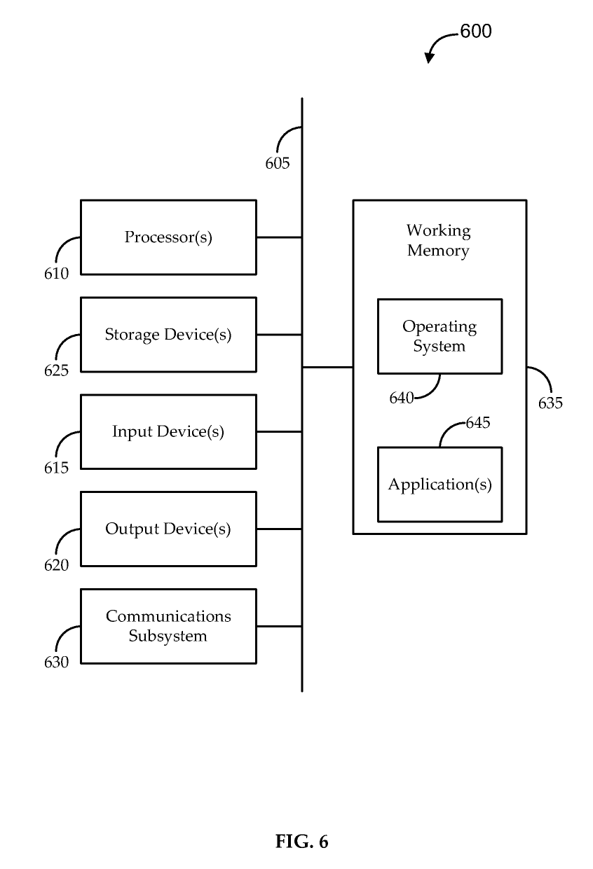

FIG. 6 shows a simplified block diagram of an illustrative computational system 600 for use in implementing components of various embodiments. For example, components of the computational system 800 may be used to implement functionality of the base station system 110 or the client subsystem 140 (e.g., or the associated tablet system 120 or handset system 130). It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computational system 600 is shown to include hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard and/or the like; and one or more output devices 620, which can include without limitation a display device, a printer and/or the like.

The computational system 600 may further include (and/or be in communication with) one or more storage devices 625, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 600 might also include a communications subsystem 630, which can include without limitation a modem, a network card (wireless or wired), an infrared communication device, a wireless communication device and/or chipset (such as a Bluetooth device, an 602.11 device, a WiFi device, a WiMax device, cellular communication facilities, etc.), and/or the like. The communications subsystem 630 may permit data to be exchanged with a network (such as the network described below, to name one example), and/or any other devices described herein. In many embodiments, the computational system 600 will further include a working memory 635, which can include a RAM or ROM device, as described above.

The computational system 600 also can include software elements, shown as being currently located within the working memory 635, including an operating system 640 and/or other code, such as one or more application programs 645, which may include computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 625 described above.

In some cases, the storage medium might be incorporated within the computational system 600 or in communication with the computational system 600. In other embodiments, the storage medium might be separate from a computational system 600 (e.g., a removable medium, such as a compact disc, etc.), and/or provided in an installation package, such that the storage medium can be used to program a general purpose computer with the instructions/code stored thereon. These instructions might take the form of executable code, which is executable by the computational system 600 and/or might take the form of source and/or installable code, which, upon compilation and/or installation on the computational system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs the computational system 600 to perform methods of the invention. According to a set of embodiments, some or all of the procedures of such methods are performed by the computational system 600 in response to processor 610 executing one or more sequences of one or more instructions (which might be incorporated into the operating system 640 and/or other code, such as an application program 645) contained in the working memory 635. Such instructions may be read into the working memory 635 from another machine-readable medium, such as one or more of the storage device(s) 625. Merely by way of example, execution of the sequences of instructions contained in the working memory 635 might cause the processor(s) 610 to perform one or more procedures of the methods described herein.

The terms “machine-readable medium” and “computer readable medium”, as used herein, refer to any medium that participates in providing data that causes a machine to operate in a specific fashion. In an embodiment implemented using the computational system 600, various machine-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 625. Volatile media includes, without limitation, dynamic memory, such as the working memory 635. Transmission media includes coaxial cables, copper wire and fiber optics, including the wires that comprise the bus 605, as well as the various components of the communication subsystem 630 (and/or the media by which the communications subsystem 630 provides communication with other devices).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computational system 600. The communications subsystem 630 (and/or components thereof) generally will receive the signals, and the bus 605 then might carry the signals (and/or the data, instructions, etc., carried by the signals) to the working memory 635, from which the processor(s) 610 retrieves and executes the instructions. The instructions received by the working memory 635 may optionally be stored on a storage device 625 either before or after execution by the processor(s) 610.

Content-Driven Navigation Embodiments

It will be appreciated from the above description that the systems, devices, and methods described above may be used to facilitate many different types of functionality. One type of functionality involves using the user supersystem 100 as an interactive communications hub for a family or household. Interactions with the communications hub may provide access to many different types of functionality, including communications, multimedia, and/or other functionality. Embodiments implement techniques for intuitive, content-driven navigation through the various features provided by the communications hub.

As used herein, the term, “family” (also referred to as a “household”), is intended generally to describe any relatively small group of parties (e.g., individuals, groups, entities, etc.), who may or may not be directly related and who tend to share a space (or other close interests) and tend to communicate frequently about issues, including issues affecting the shared space. Similarly, the term, “home,” as used herein, generally describes the shared space and/or close interests of the “family.” In various embodiments, “contacts” may be stored for the family and/or for individual members of the family. Each “contact” may generally refer to a party (e.g., individual, entity, group, other family, other user supersystem 100, etc.) for which at least one member of the family has stored associated contact information.

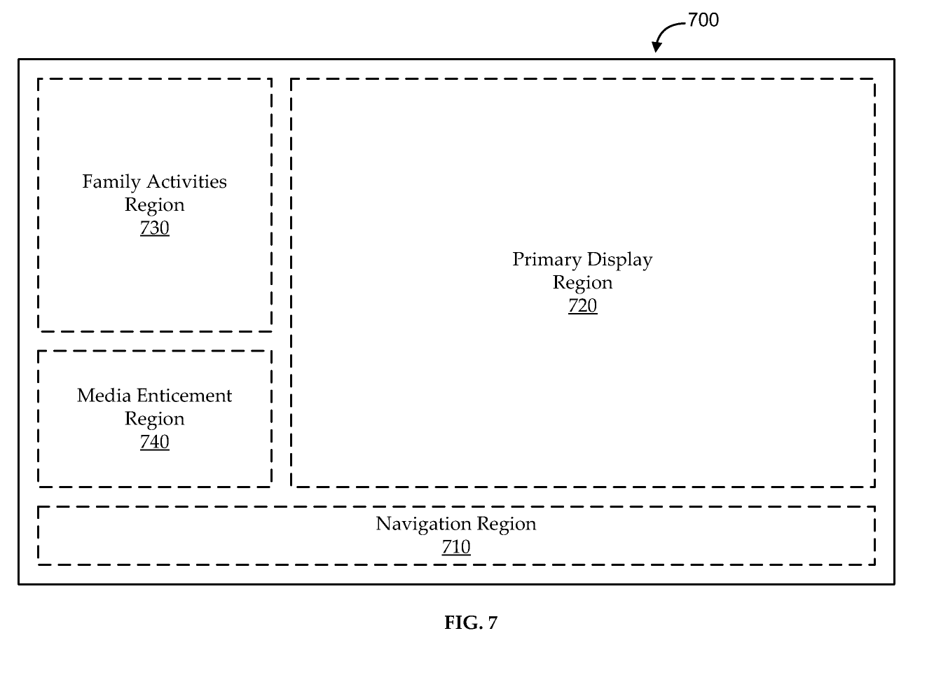

Turning first to FIG. 7, an illustrative display configuration 700 is shown for an interactive graphical interface through which content-driven navigation techniques are implemented, according to various embodiments. In some embodiments, the display configuration 700 is shown on the tablet system 120, for example, as a home screen. The display configuration 700 includes a navigation region 710, a primary display region 720, a family activities region 730, and a media enticement region 740. These regions are intended to be illustrative only, and should not be construed as limiting the scope of the invention.

In some embodiments, the navigation region 710 includes one or more icons configured to guide the user to major categories of functionality, implemented as “landing screens.” For example, the navigation region 710 may include “Home,” “Phone,” “Messaging,” and “Info” icons. The “Home” icon may provide the user with a home dashboard screen from which frequently accessed functionality may be available, the “Phone” icon may provide the user with access to calling features (e.g., voice and/or video calls, address books, etc.), the “Messaging” icon may provide the user with access to messaging features (e.g., integrated family- and/or user-specific messaging lists, chat functions, etc.), and the “Info” icon may provide the user with access to other informational types of functionality (e.g., access to the Internet, search functions, drawing applications, etc.).

Embodiments of the family activities region 730 display family activity-related information and may act as an intuitive portal to activity-related application screens. For example, certain communications contexts may drive use of family activities, which may include family messages that are associated with a particular date (e.g., or a recurring date), urgency, expiration, etc. In some embodiments, the family activities region 730 also includes user-based activities (e.g., tasks, notes, and/or activities associated with a particular family member). For example, the family activities region 730 may include a list of all activities for all family members due that day. In certain embodiments, the family activities region 730 further includes related information, such as a calendar, date and time, current weather, etc. As described more fully below, interacting with the family activities region 730 may navigate the user to one or more activity-related application pages.

Embodiments of the media enticement region 740 may include one or more features to encourage users to interact with multimedia content functionality of the user supersystem 100. For example, the media enticement region 740 may include a dynamic content portal designed to look like a stack of photos, with a most recent family photo (e.g., uploaded to the user supersystem 100, taken by the tablet system 120 camera, taken by the handset system 130 camera, etc.) on top of the virtual stack. Clicking on the “photo stack” may navigate the user to a photo booth application page, which may be a further portal to various types of media capture and/or editing functionality.

Notably, many typical home screen environments for graphical computing interfaces include a set of icons through which applications may be accessed. In this icon-driven navigation environment, a user may actively initiate a particular application to access certain functional content. On the contrary, embodiments of the display configuration 700 are content-driven, so that content is presented at the forefront of the user experience, driving the user's navigation experience.

For example, in a typical navigation paradigm, a user interacts with an application to gain access to content. In embodiments of the content-based navigation paradigm, a user interacts with content to gain access to applications. According to some embodiments, content-driven navigation functionality effectively assigns applications to nodes of a data flow, where the data flow is configured to be traversed using content shown at each node.

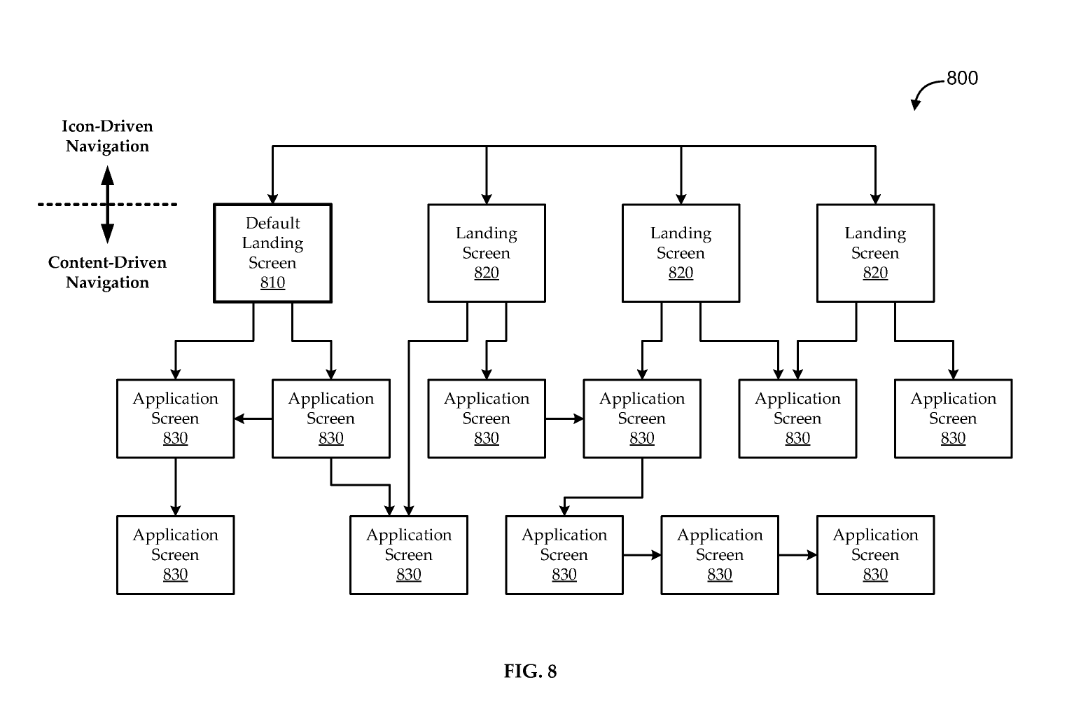

FIG. 8 shows a simplified block diagram of a content data flow 800 for providing content-based navigation functionality, according to various embodiments. According to various embodiments, the content data flow 800 can be considered as a hierarchy or as a network. For example, in certain embodiments, there may effectively be a top hierarchical level of the content data flow 800 from which a web of non-hierarchical application nodes may be reached via interactions with content. As illustrated, each node may be a display screen having certain functionality, for example, provided by one or more applications. In an embodiment, the system provides a hierarchical set of navigation screens, which implement the hierarchy of the content data flow, for example, by storing data for creating the navigation screens and/or by displaying the screens as described in further detail below.

In the illustrative embodiment shown, the top level of the content data flow 800 includes a number of landing screens 820. In one embodiment, one of the landing screens 820 is the default landing screen 810. For example, the default landing screen 810 may be a main dashboard screen that is the first screen to come on when the user supersystem 100 is turned on (e.g., or the system may automatically revert to the default landing screen 810 after some period of inactivity). The default landing screen 810 may include content-driven navigation via various content portals, as well as a limited number of icons for icon-based navigation to the other landing screens 820.

As described above, the landing screens 820 (e.g., including the default landing screen 810) are provided in certain embodiments as additional pages of content-driven navigation bases. For example, packing all the content-driven navigation onto the single dashboard screen 810 may cause the content on that page to become unusable without “clicking through” the content to get to applications. In that case, the default landing screen 810 may effectively devolve into an icon-driven navigation environment.

According to some embodiments, then, the landing screens 820 are configured to be top-level portals to general categories of functionality. In some embodiments, the only icon-driven navigation is between the various landing screens 820. For example, in one embodiment, any landing screen 820 is accessible from any other landing screen 820 using icon-driven navigation (e.g., using a static set of icons corresponding to each landing screen 820 shown in a navigation region 710 of each landing screen 820).

Content on the various screens can then be used to navigate through various applications and their respective functionality. For example, as illustrated, different application screens 830 are accessible in different ways. Some application screens 830 are directly accessible from the landing screens 820. Other application screens 830 are accessible only through other application screens 830. Notably, according to some embodiments, application screens 830 can only be accessed by interacting with content on one or more of the application screens' 830 referring screens.

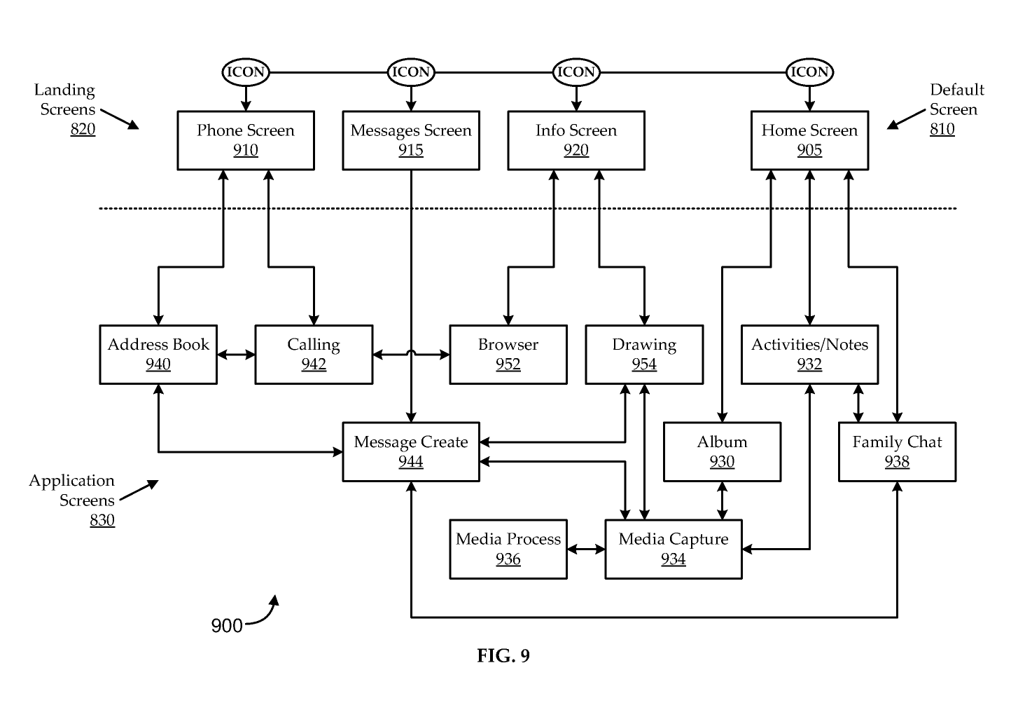

FIG. 9 shows a simplified block diagram of an embodiment of a content data flow 900 for providing content-based navigation functionality. For example, the content data flow 900 is an embodiment of the content data flow 800 of FIG. 8, and includes multiple landing screens 820 and multiple application screens 830. As shown, the default landing screen 810 may be a home screen 905, like the one described with reference to FIG. 7. The home screen 905 includes a navigation region (e.g., navigation region 710 of FIG. 7) including icons for navigating to the other landing screens 820, including a phone screen 910, a messages screen 915, and an info screen 920.

The content data flow 900 indicates that navigation between the landing screens 820 may be icon-driven, while all other navigation (e.g., from landing screens 820 to application screens 830, and from application screens 830 to application screens 830) may be content-driven. By interacting with content on any of the landing screens 820, a user may access functionality of one or more application screens 830. For example, as illustrated, interactions with content on the home screen 905 may provide access to functionality of a media album 930 application, an activities/notes 932 application, and/or a family chat 938 application. Interactions with content on the phone screen 910 may provide access to functionality of an address book 940 application and/or a calling 942 application (e.g., for making voice or video calls). Interactions with content on the messages screen 915 may provide access to functionality of a message create 944 application. Interactions with content on the info screen 920 may provide access to functionality of a browser 952 application and/or a drawing 954 application.

Further, some of the application screens 830 may be accessible through one or more other application screens 830. For example, in addition to accessing the message create 944 application through the messages landing screen 915, the message create 944 application may also be accessible through interactions with content on the address book 940 or family chat 938 application screens 830. In turn, interactions with content on the message create 944 application screen 830 may be used to access functionality of the drawing 954 application and/or a media capture 934 application. The media capture 934 application functionality may also be accessible through interactions with content on the media album 930, the activities/notes 932, and/or the drawing 954 application screens 830; and interactions with content on the media capture 934 application screen 830 may provide access to additional functionality of the drawing 954 application and/or functionality of a media processing 936 application.

It will be appreciated that many types of content-driven navigation are possible according to various embodiments. For example, content can be used in a number of ways to navigate through different types of application and content networks, having different arrangements of and interactions between nodes. As such, the content data flow 800 of FIG. 8 and the content data flow 900 of FIG. 9 are intended to be illustrative only, and should not be construed as limiting the scope of the invention.

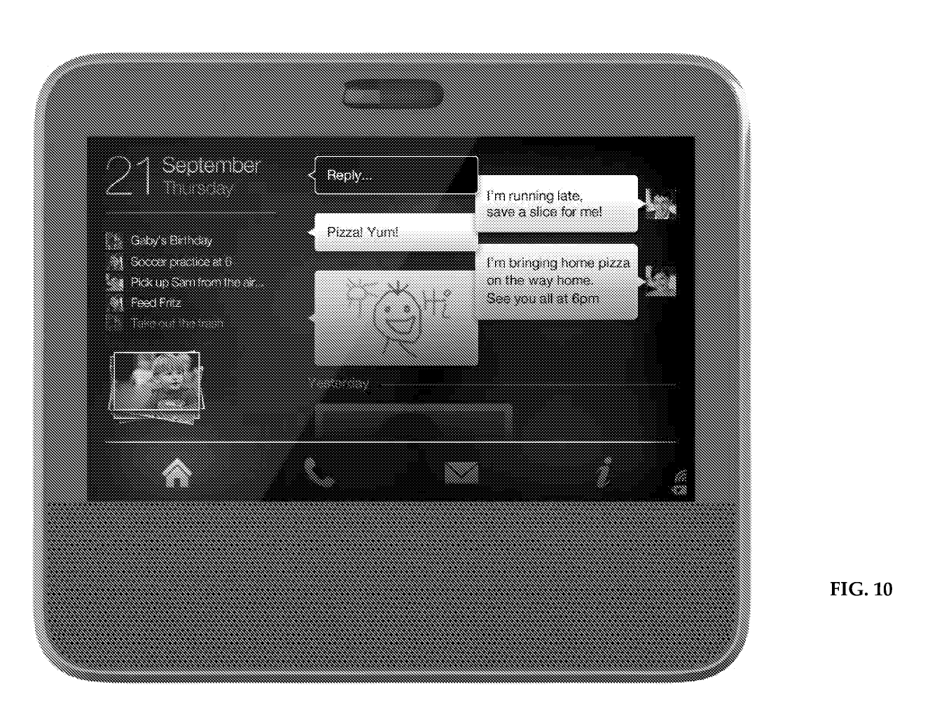

Further illustrative content-driven navigation functionality will be appreciated through screenshots shown in FIGS. 10-17. Turning first to FIG. 10, a screenshot is shown of an illustrative home screen 905. The embodiment of the home screen 905 is configured substantially as the display configuration 700 of FIG. 7, with a navigation region 710, a primary display region 720, a family activities region 730, and a media enticement region 740.

As illustrated, the only traditional icons are in the navigation region 710, where each icon corresponds to a landing screen 820. In some embodiments, all landing screen icons are shown, including the one corresponding to the currently displayed landing screen 820, for example, to maintain a common look and feel across the landing screens 820 (e.g., even though the icon corresponding to the current page may be inactive on that page, in certain embodiments). A similar or identical navigation region 710 may be shown on all landing screens 820, allowing quick switching between their respective categories of functionality.

The other regions of the illustrated home screen 905 include content configured to act as content-driven navigation portals. For example, the primary display region 720 shows family chat content, which may represent a continuous feed of chat data among all the members of a predefined family group. In some embodiments, interacting with the “Reply” bubble may provide access to the message create 944 application, whereby the user that interacted with the family chat content can create and post a contribution to the feed.

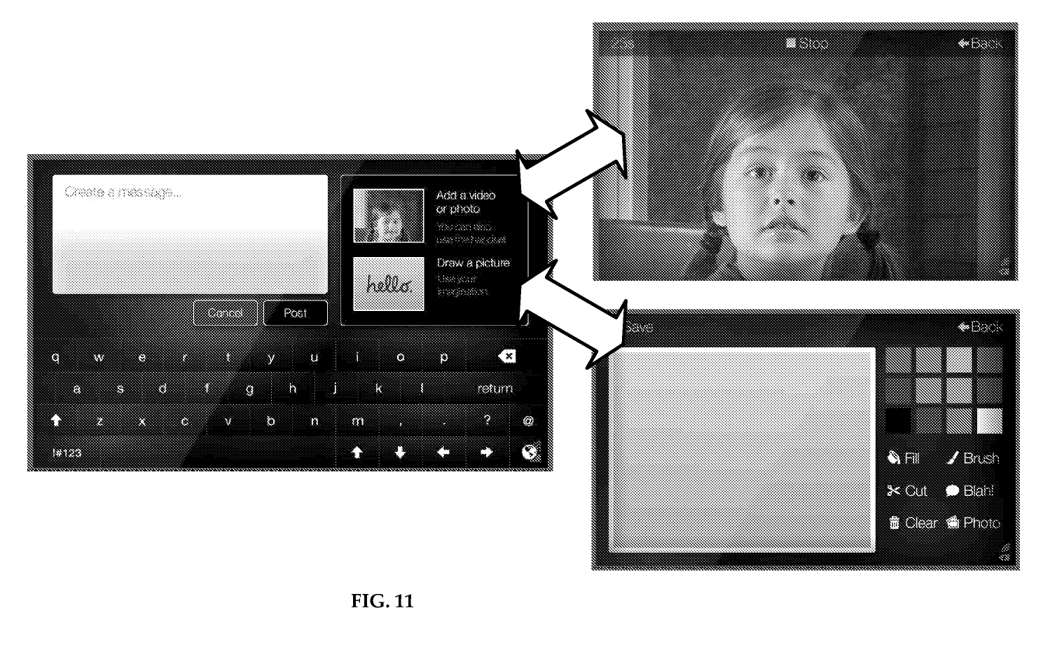

For example, FIG. 11 shows an embodiment of the message create 944 application that may be accessed by interacting with family chat content in the primary display region 720 of the home screen 905. In some embodiments, the message create 944 application is a portal to additional content accessible via content-driven navigation. For example, interacting with the photo on the message create 944 application screen 830 may provide access to the media capture 934 application and/or the media album 930 application, either or both of which may further provide access to the media processing 936 application, the drawing 954 application (e.g., for drawing in context of a photo, etc.), etc. Similarly, interacting with a doodle on the message create 944 application screen 830 may provide access to the drawing 954 application.

Returning to the illustrative home screen 905 of FIG. 10, the family activities region 730 shows a date indication and a list of current family activities (e.g., and tasks, notes, etc.). In one embodiment, interacting with the date indication may open an application showing current time and date, which may be a further portal to functionality, such as world time, current weather, etc. In another embodiment, interacting with the list of family activities may open the activities/notes 932 application, which may be a further portal to functionality, such as an integrated user-based task list, the media capture 934 application, etc.

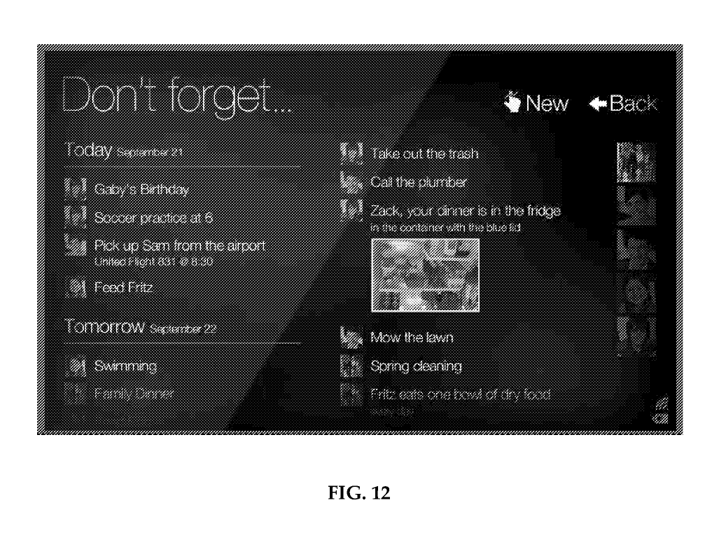

For example, FIG. 12 shows an embodiment of the activities/notes 932 application that may be accessed by interacting with family activities content in the family activities region 730 of the home screen 905. In some embodiments, the activities/notes 932 application is a portal to additional content accessible via content-driven navigation. For example, interacting with photos of family members (e.g., shown at the right side of the activities/notes 932 application screen 830) may filter or sort activities corresponding to the selected photo. Similarly, interacting with the activities themselves may provide more activity details, etc.

Returning again to the home screen 905 of FIG. 10, the media enticement region 740 shows a “photo stack,” as described above. Interacting with the “photo stack” may provide access to the media album 930 application, which may further be a portal to functionality, such as the media capture 934 application. The media capture 934 application may even further provide access to the media processing 936 application, the drawing 954 application (e.g., for drawing in context of a photo, etc.), etc.

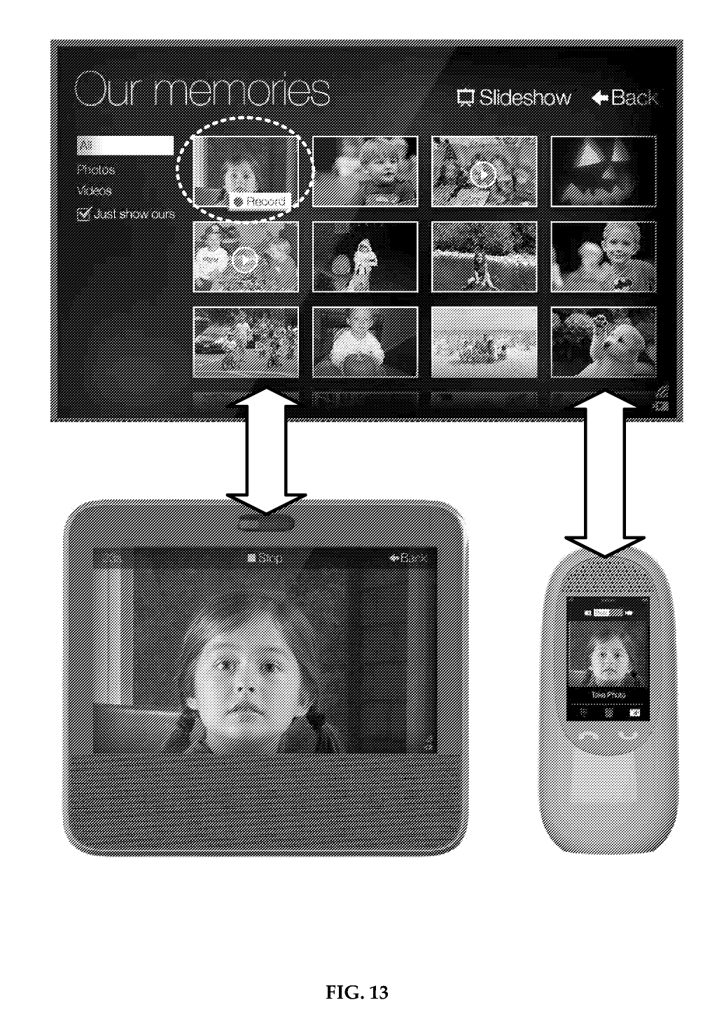

For example, FIG. 13 shows an embodiment of the media album 930 application that may be accessed by interacting with photo stack content in the media enticement region 740 of the home screen 905. In some embodiments, the media album 930 application is a portal to additional content accessible via content-driven navigation. For example, embodiments of the media album 930 application screen 830 include a live video thumbnail, configured to show a current live video feed coming from a camera of the user supersystem 100. interacting with the live video thumbnail on the media album 930 application screen 830 may provide access to a media capture 934 application (e.g., on the tablet system 120, the handset system 130, etc.).

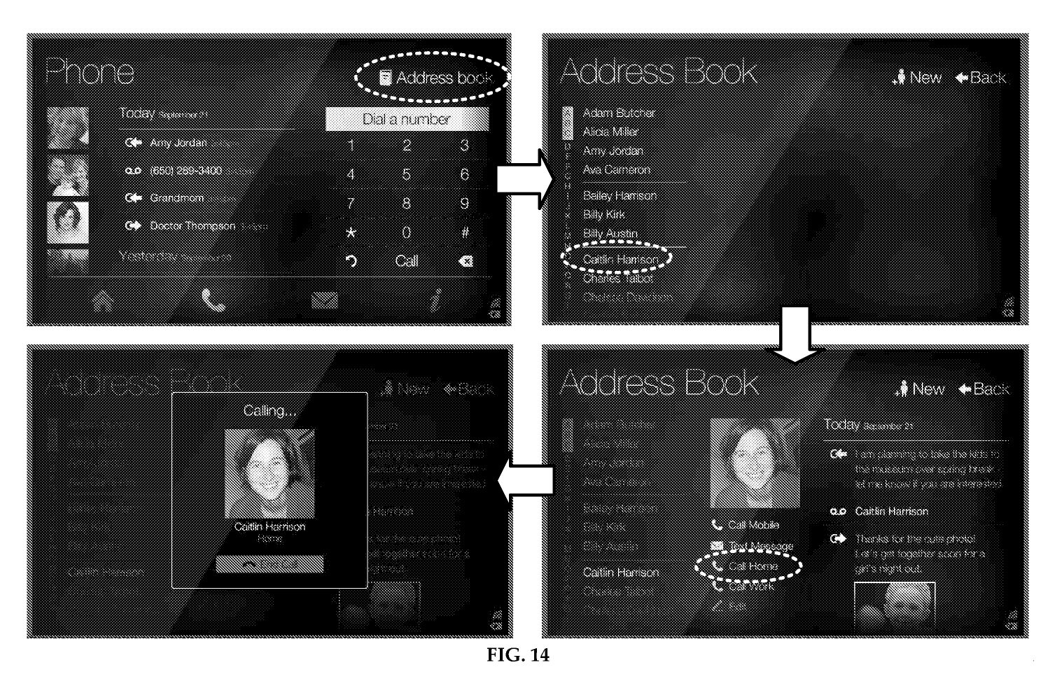

Each of the other landing screens 820 (e.g., accessible via the landing screen icons in the navigation region 710 of the home screen 905) may include its own content-driven navigation functionality. For example, the phone screen 910 may look similar to the top-left screenshot of FIG. 14. The calling 942 application driving much of the functionality on the phone screen 910 may include functionality, such as speed dial entries (e.g., via interactions with photos on the left side of the screen), incoming and outgoing communications listings (e.g., identified as missed calls, voicemails, etc.), a phone keypad, etc.

In some embodiments, interacting with these various types of content (e.g., the photos, the message listings, etc.) may provide additional functionality through the calling 942 application and/or the address book 940 application. In some embodiments, the address book 940 application may be accessed by interacting with the “Address Book” indication on the phone screen 910.

In one embodiment, the address book 940 application screen 830 looks like the top-right screenshot of FIG. 14. Interacting with one of the contact listings on the address book 940 application screen 830 may add contact information to the address book 940 application screen 830 for the selected content. For example, selecting “Caitlin Harrison,” brings up her contact information. The conversation information may include a conversation history, a photo, and various speed dial (e.g., or speed messaging) entries, for example, as shown in the bottom-right screenshot of FIG. 14.

Interacting with one of the speed dial entries may initiate a call to the phone number associated with the speed dial entry. For example, interacting with Caitlin Harrison's “Home” entry may cause the calling 942 application to call Caitlin Harrison's home phone number. The resultant screen may look similar to the one shown in the bottom-left screenshot of FIG. 14.

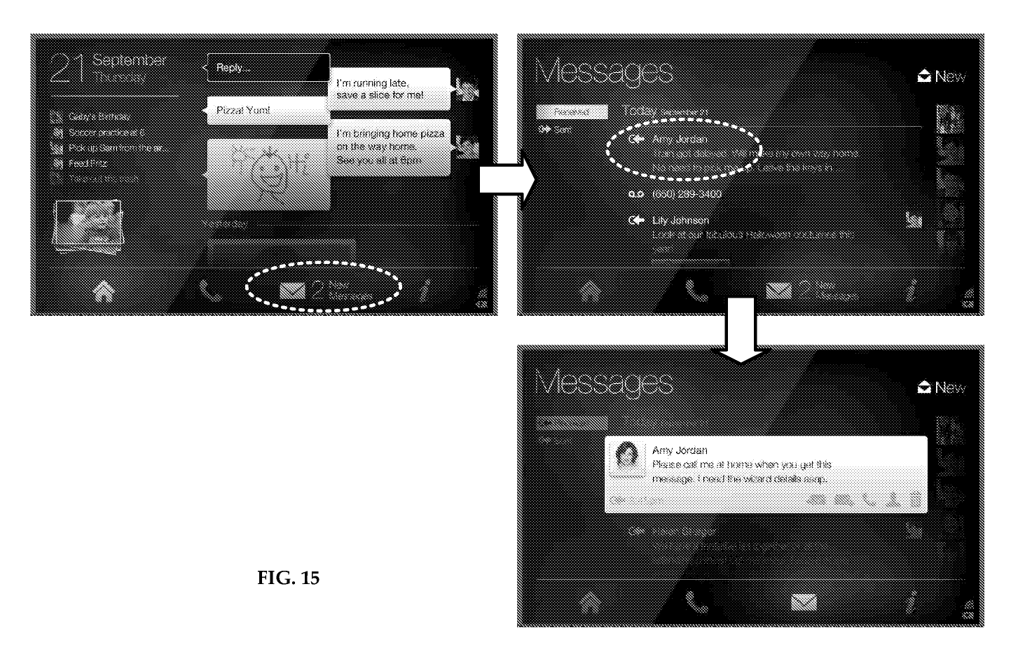

Turning to the messages landing screen 915, additional functionality is available, according to various embodiments. In some embodiments, unread messages are indicated as a modified messages navigation icon in the navigation region 710 of the home screen 905. For example, an illustrative screenshot of a home screen with a modified messages navigation icon is shown as the top-left screenshot of FIG. 15. The modified messages navigation icon indicates two new messages.

Whether selecting the normal or modified messages navigation icon, the user may be taken to the messages landing screen 915. In some embodiments, the messages landing screen 915 looks like the top-right screenshot of FIG. 15. As illustrated, the messages landing screen 915 may include an integrated messaging interface on which various types of messages are listed in an intuitive format. For example, the integrated messaging interface may list incoming and outgoing phone calls, voicemails, sent and received asynchronous messages (e.g., SMS, MMS, email, etc.), etc.

In some embodiments, interacting with the photos at the right side of the screen may filter or sort the messages on a per-user (e.g., or per-user-group) basis. In other embodiments, interacting with the messages listing may provide a portal to various types of functionality. For example, interacting with a message may access further portions and details of the message.

Interacting with a message may also provide functionality for responding to the message using one or more communications modes. Some of these functions are illustrated in the bottom-right screenshot of FIG. 15. For example, selecting to respond to the message via asynchronous messaging may navigate the user to the message create 944 application (e.g., as shown in FIG. 11).

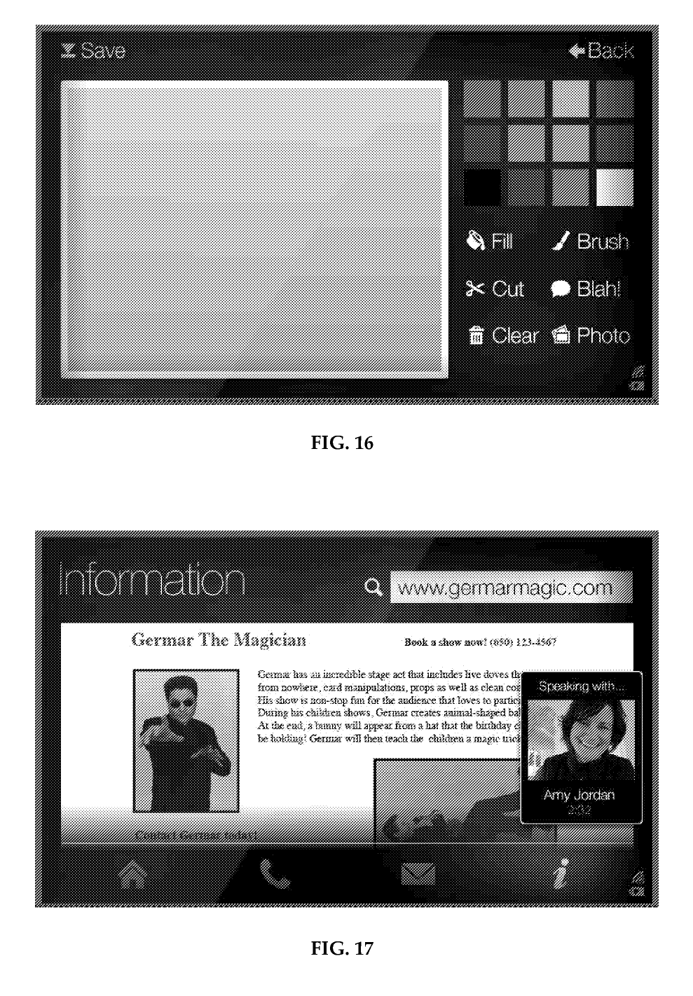

Turning to the information landing screen 920, various embodiments provide access to different applications. In some embodiments, the information landing screen 920 shows frequently accessed content, which can be used as portals to application functionality. In other embodiments, the information landing screen 920 provides a number of icons for icon-based navigation to various applications. For example, as shown in FIGS. 16 and 17, respectively, the information landing screen 920 may provide access to the browser 952 application (e.g., for navigating the worldwide web), the drawing 954 application, etc. In some embodiments, the information landing screen 920 provides access to system settings menus (e.g., for setting preferences, date and time, etc.).

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware, and/or software configurator. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added, and/or subtracted from among other described embodiments, unless the context dictates otherwise.

What is claimed is:

1. A communication system for providing content-driven navigation, the system comprising:
a display device;
an input device; and
a computing device in communication with the display device and the input device, the computing device comprising at least one processor and at least one computer readable storage medium in communication with the at least one processor, the at least one computer readable storage medium having encoded thereon a set of instructions that are executable by the processor to cause the computer system to perform one or more operations, the set of instructions comprising:
instructions for providing a hierarchical set of navigation screens to serve as a portal to content-related activities, the hierarchical set of navigation screens comprising:
a first level of a navigation screen hierarchy, the first level comprising a first landing screen comprising a first type of content; and
a second level of the navigation screen hierarchy, the second level comprising a first application screen, the first application screen providing a user interface for interacting with the first type of content using a first application;
instructions for displaying, on the display screen, the first landing screen;
instructions for receiving, with the input device, a user interaction with the first type of content;
instructions for displaying the first application screen, in response to the interaction with the first type of content; and
instructions for providing functionality to the user, with the first application, pertaining to the first type of content.

2. The system of claim 1, wherein the computing device is part of a supersystem for providing interactive communications services within a local network, the supersystem comprising:
a tablet system, comprising a first client subsystem of the local network and a first user interface module configured to provide interactivity with first communications services provided by the first client subsystem;
a handset system, comprising a second client subsystem of the local network and a second user interface module configured to provide interactivity with second communications services provided by the second client subsystem; and
a base station system, comprising:
a first interface subsystem configured to communicatively and removably couple the base station with the tablet system;
a second interface subsystem configured to communicatively and removably couple the base station with the handset system; and
a communications subsystem configured to communicatively couple the base station with the local area network such that at least a portion of the first and second communications services are provided via the base station.

3. The system of claim 2, wherein the base station system comprises the computing device.

4. The system of claim 2, wherein the tablet system comprises the computing device.

5. The system of claim 2, wherein the tablet system comprises the display device and the input device.

6. The system of claim 2, wherein the handset system comprises the display device and the input device.

7. The system of claim 1, wherein the display device comprises a touchscreen that serves as the input device.

8. The system of claim 1, wherein the computing device is a household communication hub comprising the display device and the input device.

9. The system of claim 1, wherein the first level of the navigation screen hierarchy comprises a plurality of landing screens, in addition to the first landing screen.

10. The system of claim 9, wherein:
the first landing screen is a default landing screen; and
the set of instructions further comprises:
instructions for displaying the first landing screen when the system starts up; and
instructions for displaying the first landing screen after a period of system inactivity.

11. The system of claim 9, wherein:
the plurality of landing screens comprises a second landing screen, and the first landing screen comprises a plurality of icons corresponding to the plurality of landing screens, including an icon corresponding to the second landing screen; and
the set of instructions further comprises:
instructions for receiving a user selection of the icon corresponding to the second landing screen; and
instructions for displaying the second landing screen, in response to the user selection of the icon corresponding to the second landing screen.

12. The system of claim 1, wherein:
the first application screen further comprises a second type of content; and
the second level of the navigation screen hierarchy further comprises a second application screen, the second application screen providing a user interface for interacting with the second type of content using a second application.

13. The system of claim 12, wherein the set of instructions further comprises:
instructions for receiving a second user interaction with the second type of content;
instructions for displaying the second application, in response to the second user interaction with the second type of content; and
instructions for providing functionality to the user, with the second application, pertaining to the second type of content.

14. The system of claim 1, wherein the first type of content comprises media content selected from the group consisting of a photo, a video clip, and an audio clip.

15. The system of claim 14, wherein the first application is a media editing application or a media album application.

16. The system of claim 15, wherein:
the first application is a media capture application;
the communication system further comprises a media capture device in communication with the computing device; and
the set of instructions further comprises:
instructions for capturing, with the media capture application, additional media of the first type, received from the media capture device.

17. The system of claim 1, wherein the first type of content is messaging content, and wherein the first application is a message create application.

18. The system of claim 1, wherein the first type of content is address book content, and wherein the first application is a phone application.

19. An apparatus, comprising:
a computer readable medium having encoded thereon a set of instructions executable by one or more computers to perform one or more operations for providing content-driven navigation, the set of instructions comprising:
instructions for generating a hierarchical set of navigation screens to serve as a portal to content-related activities, the hierarchical set of navigation screens comprising:
a first level of a navigation screen hierarchy, the first level comprising a first landing screen comprising a first type of content; and
a second level of the navigation screen hierarchy, the second level comprising a first application screen, the first application screen providing a user interface for interacting with the first type of content using a first application;
instructions for displaying, on a display screen, the first landing screen;
instructions for receiving, with an input device, a user interaction with the first type of content;
instructions for displaying the first application screen, in response to the interaction with the first type of content; and
instructions for providing functionality to the user, with the first application, pertaining to the first type of content.

20. A method of providing content-driven navigation, the method comprising:
generating, at a computing device, a hierarchical set of navigation screens to serve as a portal to content-related activities, the hierarchical set of navigation screens comprising:
a first level of a navigation screen hierarchy, the first level comprising a first landing screen comprising a first type of content; and
a second level of the navigation screen hierarchy, the second level comprising a first application screen, the first application screen providing a user interface for interacting with the first type of content using a first application;
displaying, on a display screen, the first landing screen;
receiving, with an input device, a user interaction with the first type of content;
displaying the first application screen, in response to the interaction with the first type of content; and
providing functionality to the user, with the first application, pertaining to the first type of content.
